(19) United States
(12) Patent Application Publication
(10) Pub. No.: US 2026/0189782 A1
(43) Pub. Date: Jul. 2, 2026

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: YUKA IGARASHI, Tokyo (JP)

(21) Appl. No.: 19/424,439

(22) Filed: Dec. 18, 2025

(30) Foreign Application Priority Data
Dec. 27, 2024 (JP) 2024-233108

(51) Int. Cl. H04N 23/62

(52) U.S. Cl. CPC H04N 23/62

(57) ABSTRACT

An apparatus obtains information indicating function allocation for a first operation member on a first device, and allocates a function to a second operation member on a second device based on the information. The second operation member detects multiple input levels, and a function is allocated for each level. The apparatus identifies the corresponding second operation member, and if the total number of input levels differs, determines the function allocated to the second operation member to be common with that of the first operation member.

### BACKGROUND

### Field of the Technology

The present disclosure relates to an information processing apparatus, a control method, and a storage medium and particularly relates to technology for customizing the function invoked when an operation input to an operation member is detected.

### DESCRIPTION OF THE RELATED ART

An electronic device such as a digital camera is configured to, when an operation input to an operation member provided on the electronic device is detected, invoke the function allocated to the operation member. However, there is a possibility that the default functions allocated to operation members at the time the electronic device is shipped are not necessarily easy-to-use for all users. Thus, in the electronic device, a customization function is provided for changing the function allocated to at least one operation member. According to the customization function, for example, if the user allocates functions used in succession to operation members in the vicinity of each other, these functions can be swiftly used without the need to change the hold of the electronic device.

Preferably, the allocation of customized functions to operation members in this manner can also be applied when the user uses another similar type of electronic device. Thus, there is a demand for a mechanism that enables information on the allocation of a customized function to an operation member to be carried over between electronic devices.

A switch or the like that is configured to detect different operation input based on the amount of pressing is known among operation members employed in a digital camera or the like (Japanese Patent Laid-Open No. 2001-346080). However, an operation member configured to detect different levels of operation input in this manner is not necessarily provided in all electronic devices, and therefore even if information on the allocation of a function to an operation member is carried over between electronic devices, the function distribution may not be as desired by the user.

### SUMMARY

The present technology has been made in consideration of the aforementioned problems and provides an information processing apparatus, a control method, and a storage medium for favorably implementing carry-over of function allocation to an operation member between electronic devices including operation members with a different number of levels for an operation input that can be detected.

The present disclosure, in one aspect, provides an information processing apparatus that allocates, to an operation member included in an electronic device, a function invoked in response to detection of operation input to the operation member, comprising: at least one processor and/or circuit; and at least one memory storing a computer program, which causes the at least one processor and/or circuit to function as the following units: an obtaining unit configured to obtain setting information indicating allocation of a function to an operation member included in a first electronic device; and an allocating unit configured to allocate a function to an operation member included in a second electronic device based on the setting information, wherein the operation member is configured to detect one or more levels of operation input and be allocated a function invoked in response to detection of operation input for each of the one or more levels of operation input, the allocating unit includes an identifying unit configured to identify a second operation member included in the second electronic device corresponding to a first operation member included in the first electronic device, and in a case where a total number of levels of operation input that can be detected is different between the first operation member and the second operation member, the allocating unit determines a function to be allocated to operation input of the second operation member in such a manner that the function allocated to operation input of the second operation member is in common with a function allocated to operation input of the first operation member.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1A is a diagram illustrating an example of the configuration of a system according to embodiments and modification examples of the present technology.

FIG. 1B is a diagram illustrating an example of the configuration of a system according to embodiments and modification examples of the present technology.

FIG. 2 is a block diagram illustrating an example of the hardware configuration of a smartphone 100 according to embodiments and modification examples of the present technology.

FIG. 3 is a block diagram illustrating an example of the hardware configuration of a camera 200 according to embodiments and modification examples of the present technology.

FIG. 4A is a diagram illustrating an example of the external appearance of the camera 200 according to embodiments and modification examples of the present technology.

FIG. 4B is a diagram illustrating an example of the external appearance of the camera 200 according to embodiments and modification examples of the present technology.

FIG. 5A is a diagram illustrating an example of member information of the camera 200 according to embodiments and modification examples of the present technology.

FIG. 5B is a diagram illustrating an example of member information of the camera 200 according to embodiments and modification examples of the present technology.

FIG. 6A is a diagram illustrating an example of function candidate information of the camera 200 according to embodiments and modification examples of the present technology.

FIG. 6B is a diagram illustrating an example of function candidate information of the camera 200 according to embodiments and modification examples of the present technology.

FIG. 7A is a diagram illustrating an example of allocation information of the camera 200 according to embodiments and modification examples of the present technology.

FIG. 7B is a diagram illustrating an example of allocation information of the camera 200 according to embodiments and modification examples of the present technology.

FIG. 8 is a diagram illustrating an example of a carry-over settings screen according to a first embodiment of the present technology.

FIG. 9 is a flowchart illustrating an example of carry-over processing according to embodiments and modification examples of the present technology.

FIG. 10 is a flowchart illustrating an example of generation processing according to the first embodiment of the present technology.

FIG. 11 is a flowchart illustrating an example of determination processing according to the first embodiment of the present technology.

FIG. 12 is a flowchart illustrating an example of confirmation processing according to embodiments and modification examples of the present technology.

FIG. 13 is a flowchart illustrating an example of determination processing according to Modification Example 2 of the present technology.

FIG. 14 is a diagram illustrating an example of a carry-over settings screen according to Modification Example 3 of the present technology.

FIG. 15A is a diagram illustrating an example of the external appearance configuration of an accessory apparatus 1500 according to a second embodiment of the present technology.

FIG. 15B is a diagram illustrating an example of the external appearance configuration of the accessory apparatus 1500 according to a second embodiment of the present technology.

FIG. 16 is a block diagram illustrating an example of the hardware configuration of the accessory apparatus 1500 according to the second embodiment of the present technology.

FIG. 17 is a diagram illustrating an example of a carry-over settings screen according to the second embodiment of the present technology.

FIG. 18 is a flowchart illustrating an example of determination processing according to the second embodiment of the present technology.

FIG. 19 is a diagram illustrating an example of a carry-over settings screen according to a third embodiment of the present technology.

FIG. 20 is a flowchart illustrating an example of generation processing according to the third embodiment of the present technology.

FIG. 21 is a flowchart illustrating an example of determination processing according to the third embodiment of the present technology.

FIG. 22 is a flowchart illustrating an example of confirmation processing according to the third embodiment of the present technology.

### DESCRIPTION OF THE EMBODIMENTS

### First Embodiment

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

An embodiment described below is an example of the present technology applied to a smartphone, as an example of an information processing apparatus, that executes processing to carry over a setting of allocation of a function to each operation member included in an imaging apparatus to another imaging apparatus. However, the present technology can be applied to any device that can allocate a function to an operation member included in a second electronic device based on information of allocation of a function to an operation member included in a first electronic device.

Also, in the present specification, “allocation of a function to an operation member” refers to allocating a function (such as various types of processing and sequences) to be invoked in an electronic device including the operation member, in response to the detection of an operation input to the operation member. In other words, via allocation of a function, an operation input can be set to be detectable as a trigger for the operation member to invoke the function.

### System Configuration

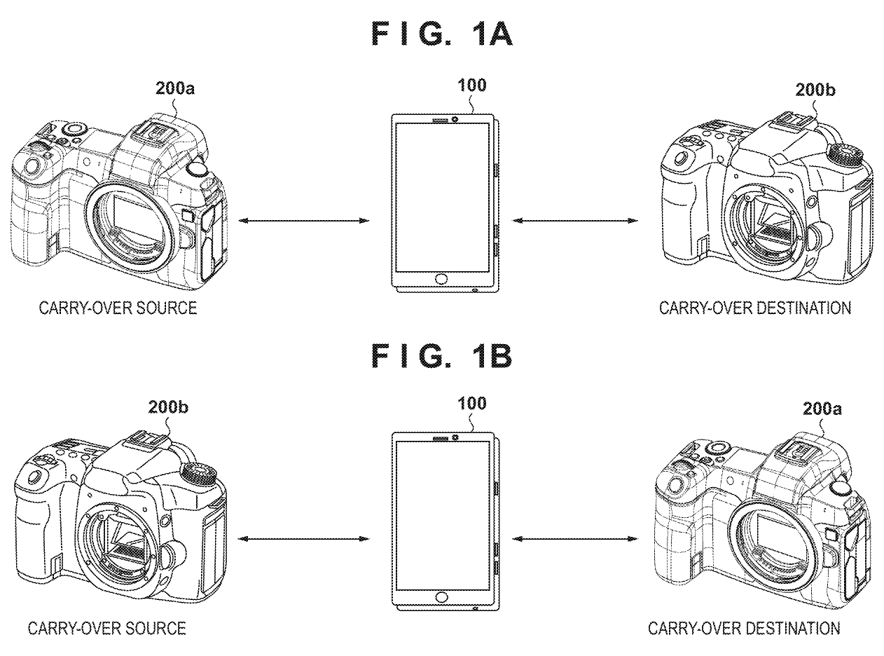

FIG. 1A is a diagram illustrating an example configuration of a system according to the present embodiment. In the present embodiment, a smartphone 100 that has obtained setting information indicating the allocation of a function to each type of operation member in a camera 200a allocates a function to each type of operation member in a camera 200b based on the setting information.

Here, the camera 200a and the camera 200b are each one aspect of an electronic device and are imaging apparatuses configured to include at least one different operation member. The camera 200a and the camera 200b have basically the same hardware configuration excluding the one operation member, and hereinafter, if there is no need to distinguish between the two, the cameras 200a and 200b may be simply referred to as the camera 200. The cameras 200a and 200b are each configured, regarding the at least one operation member, with a changeable function that is invoked when an operation input to the operation member is detected. To facilitate understanding of the technology, hereinafter, from among the operation members included in each camera 200, mainly an operation member with a changeable function allocation will be described. However, this does not exclude the camera 200 from including an operation member configured with an unchangeable function allocation.

Thus, in the carry-over of an allocation setting for a function to an operation member implemented by the smartphone 100, the camera 200a is the carry-over source and the camera 200b is the carry-over destination. Hereinafter, the camera 200a may be referred to as the “carry-over source”, and the camera 200b may be referred to as the “carry-over destination”.

Note that the communication connection between the devices in the system may be wireless or wired. Such a communication connection may include a USB or LAN cable, Wi-Fi (registered trademark), Bluetooth (registered trademark), or the like. As the communication protocol for the communication connection, any communication protocol such as PTP, HTTP, or the like may be used.

### Hardware Configuration of Smartphone 100

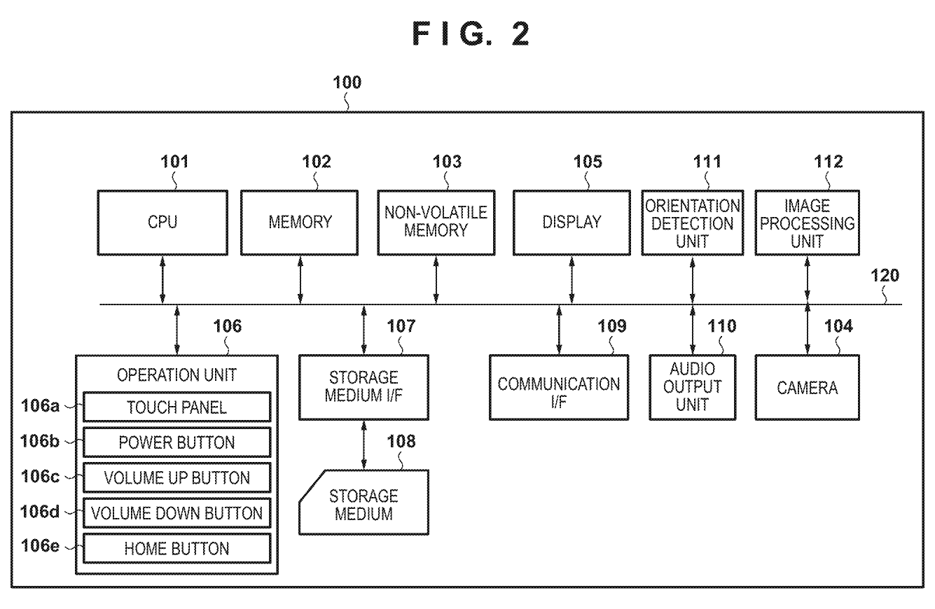

First, the hardware configuration of the smartphone 100 will be described with reference to the block diagram of FIG. 2.

In an internal bus 120, a CPU 101, a memory 102, a non-volatile memory 103, a camera 104, a display 105, an operation unit 106, a storage medium I/F 107, a storage medium 108, and a communication I/F 109 are connected. Also, in the internal bus 120, an audio output unit 110, an orientation detection unit 111, and an image processing unit 112 are also connected. Each unit connected to the internal bus 120 is configured to be able to exchange data with one another via the internal bus 120.

The CPU 101 is a control apparatus that controls the operations of each block included in the smartphone 100 and includes at least one processor or circuit. The memory 102 is RAM (volatile memory using a semiconductor element), for example. The CPU 101 controls the operations of each block of the smartphone 100 using the memory 102 as a working memory according to a program stored in the non-volatile memory 103, for example. In other words, the CPU 101 controls the operations of each block by reading out an operation program of each block stored in the non-volatile memory 103, loading this into the memory 102, and executing it. The non-volatile memory stores image data, audio data, other data, and various types of programs and the like for the CPU 101 to operate. The non-volatile memory 103 includes a flash memory, a ROM, or the like, for example.

The image processing unit 112 executes various types of image processing or object recognition processing on an image captured by the camera 104 based on control by the CPU 101. The image processing unit 112 can execute various types of image processing on an image stored in the non-volatile memory 103 or the storage medium 108 and an image signal, image, or the like obtained via the communication I/F 109.

The display 105 displays an image, a GUI screen forming a GUI, and the like based on control by the CPU 101. The CPU 101 controls each unit of the smartphone 100 to generate a display control signal according to a program and output this to the display 105. The display 105 displays an image based on the output image signal. Note that the configuration of the smartphone 100 may include up to the interface for outputting an image signal for display on the display 105 and the display 105 may be constituted by an external monitor (television).

The operation unit 106 is an input interface for receiving a user operation and may include a keyboard or similar character information input device, a mouse, a touch panel, or similar pointing device, a button, a dial, a joystick, a touch sensor, a touchpad, or the like. Note that the touch panel may be configured as a flat surface layered on the display 105 and may be configured to output coordinate information corresponding to the touched position. The operation unit 106 may include, as described above, a touch panel 106a, a power button 106b, a volume up button 106c, a volume down button 106d, a home button 106e, and the like.

For the touch panel 106a, various types of touch panels may be used, such as a resistive film type, an electrostatic capacitance type, a surface acoustic wave type, an infrared type, an electromagnetic induction type, an image recognition type, and an optical sensor type. In other words, the touch panel 106a may use any method including a method in which a touch is detected in a case where the touch panel is touched and a method in which a touch is detected in a case where a finger or stylus pen approaches the touch panel.

The storage medium I/F 107 is configured to be able to be installed with the storage medium 108, which is a memory card, a CD, a DVD, or the like. The storage medium I/F 107 reads out data from the installed storage medium 108, writes data to the storage medium 108, and the like based on control by the CPU 101. The storage medium 108 may be a built-in storage incorporated into the smartphone 100. The communication I/F 109 is an interface for a communication connection with an external device, input and output of image signals and audio signals, and the exchange of various types of information.

The audio output unit 110 outputs video audio data, audio during a call, operation sounds, ringtones, various types of notification sounds, and the like. The orientation detection unit 111 detects the orientation of the smartphone 100 with respect to the gravity direction and the inclination (yaw, roll, and pitch) of the orientation with respect to each axis. Based on the orientation detected by the orientation detection unit 111, it can be determined whether the smartphone 100 is held on the side, held vertically, pointed up, pointed down, in an inclined orientation, or the like. As the orientation detection unit 111, at least one from among an acceleration sensor, a gyro sensor, a geomagnetic sensor, an orientation sensor, an altitude sensor, and the like can be used or a plurality of these in combination can be used.

### Hardware Configuration of Camera 200

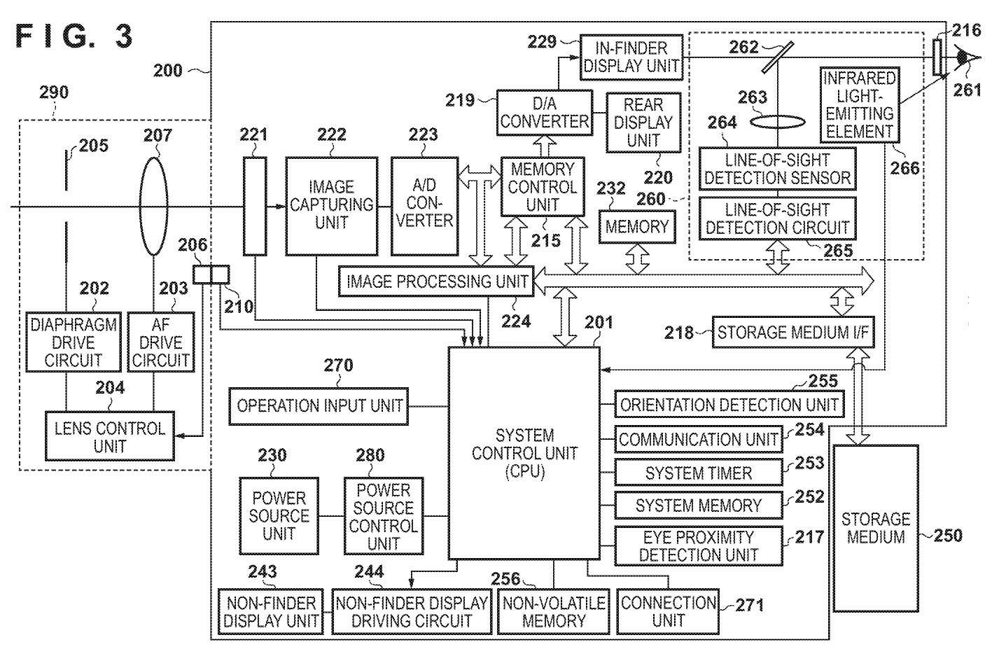

Next, the hardware configuration of the camera 200 will be described in detail with reference to the block diagram of FIG. 3.

In FIG. 3, a lens unit 290 is equipped with an imaging lens 207 and can be attached to and detached from the camera 200. The imaging lens 207, while typically being constituted by a plurality of lenses, is illustrated simply here as only one lens. A communication terminal 206 is an electrical contact for the lens unit 290 to communicate with the camera 200. A communication terminal 210 is an electrical contact for the camera 200 to communicate with the lens unit 290. The lens unit 290 communicates with a system control unit 201 via the communication terminal 206, the built-in lens control unit 204 controls a diaphragm drive circuit 202 to drive a diaphragm 205 and controls an auto focus (AF) drive circuit 203 to change the position of the imaging lens 207 to focus.

A focal plane shutter 221 can freely control the exposure time of an image capturing unit 222 according to an instruction from the system control unit 201. The image capturing unit 222 is an image sensor constituted by a CCD, CMOS, or similar image capturing element for converting a subject image into an electrical signal. An A/D converter 223 converts the analog signal of one pixel output from the image capturing unit 222 into a 10-bit digital signal, for example.

An image processing unit 224 performs a predetermined pixel interpolation, resizing processing such as reduction, color conversion processing, and the like on data from the A/D converter 223 or from a memory control unit 215. Also, in the image processing unit 224, predetermined computational processing for photometry processing and distance measuring processing is executed using the captured image data, and the system control unit 201 performs exposure control and distance measuring control based on the computation result. Accordingly, through-the-lens (TTL) AF processing, auto exposure (AE) processing, and pre-flash emission (EF) processing are executed. Also, in the image processing unit 224, predetermined computational processing for white balance processing is executed using the captured image data and TTL auto white balance (AWB) processing is executed based on the computation result. Also, the image processing unit 224 uses the captured image data to execute object detection processing to detect the type, site, state (type) of the object, the position and size (region) of the object, and the like. Also, the image processing unit 224 can perform face AF and pupil AF. Face AF refers to performing AF on a face in an image detected via object detection processing. Pupil AF refers to performing AF on a pupil of a face in an image detected via object detection processing. Also, the system control unit 201 determines a predetermined object automatically or via a user operation from one or a plurality of objects detected by the image processing unit 224 and displays a frame at the predetermined object indicating it as the target of AE processing and AF processing.

The memory control unit 215 controls the exchange of data between the A/D converter 223, the image processing unit 224, and a memory 232. The digital data output from the A/D converter 223 are directly written to the memory 232 via the image processing unit 224 and the memory control unit 215 or via the memory control unit 215. The memory 232 stores image data obtained from the image capturing unit 222 and the A/D converter 223 and data for image display for displaying on a rear display unit 220 or an in-finder display unit 229. The memory 232 is provided with enough storage capacity to store a predetermined number of still images and a predetermined amount of time of moving images and audio. Also, the memory 232 also functions as memory (video memory) for image display.

A D/A converter 219 converts data for image display stored in the memory 232 into an analog signal and supplies this to the rear display unit 220 or the in-finder display unit 229. The image data for display written to the memory 232 is displayed by the rear display unit 220 or the in-finder display unit 229 via the D/A converter 219. The rear display unit 220 and the in-finder display unit 229 perform display on the display device according to the analog signal from the D/A converter 219. In this manner, the digital signal stored in the memory 232 is converted to an analog signal, and an analog signal is successively transferred to the rear display unit 220 or the in-finder display unit 229 and displayed to implement the function of an electronic view finder (EVF) for live view display (through-the-lens image). The in-finder display unit 229 and the rear display unit 220 can use a display device such as a liquid crystal panel, an organic EL panel, or the like, for example.

A non-finder display unit 243 displays various setting values of the camera including the shutter speed, the aperture, and the like via a non-finder display driving circuit 244.

A non-volatile memory 256 is an electrically erasable and recordable EEPROM or the like, for example. Constants for operation of the system control unit 201, programs for control of each block of the camera 200, and the like are stored in the non-volatile memory 256.

The system control unit 201 includes a CPU or MPU for controlling the entire camera 200. The system control unit 201 loads a program stored in the non-volatile memory 256 into a system memory 252 and executes the program to implement each process of the flowchart described below. The system memory 252 is RAM or the like and is also used as a working memory for loading constants, variables, programs read out from the non-volatile memory 256, and the like for operation of the system control unit 201. Also, the system control unit 201 performs display control by controlling the memory 232, the D/A converter 219, the rear display unit 220, the in-finder display unit 229, and the like. A system timer 253 is a time measuring unit that measures the time used by the various controls, the time of a built-in timer, and the like.

A power source control unit 280 includes a battery detection circuit, a DC-DC converter, and a switch circuit for switching blocks to be energized and detects whether a battery is installed, the type of battery, and the remaining battery level. Also, the power source control unit 280 controls the DC-DC converter based on the detection results and an instruction from the system control unit 201 and supplies the required voltages to various components including a storage medium 250 at the required time.

A power source unit 230 includes a primary battery, such as an alkaline battery and a lithium battery, a secondary battery such as a nickel-cadmium (NiCd) battery, a nickel metal hydride (NiMH) battery, and a lithium-ion (Li) battery, and/or an alternating current (AC) adapter. A storage medium I/F 218 is an interface with the storage medium 250, such as a memory card or a hard disk. The storage medium 250 is a storage medium such as a memory card for storing captured images and is constituted by a semiconductor memory, a magnetic disk, or the like.

A communication unit 254 is connected in a communication-enabling manner to an external device via a wireless antenna or a wired cable and transmits and receives images and audio. The communication unit 254, in the present embodiment, is connected in a communication-enabling manner to the smartphone 100 and transmits and receives information. Also, the communication unit 254 can transmit image data (including live view images) captured by the image capturing unit 222 and image files stored in the storage medium 250 to an external device and can receive image data and various other types of information from an external device.

An orientation detection unit 255 detects the orientation of the camera 200 with respect to the gravity direction. Whether an image captured by the image capturing unit 222 is an image taken by the camera 200 in landscape or portrait can be determined based on the orientation detected by the orientation detection unit 255. The system control unit 201 can add orientation information based on the orientation detected by the orientation detection unit 255 to an image file of an image captured by the image capturing unit 222, or rotate and record the image. An acceleration sensor, a gyro sensor, or the like can be used as the orientation detection unit 255. The orientation detection unit 255 can detect the motion of the camera 200 (such as a pan, tilt, lift-up, at rest, and the like) using an acceleration sensor and a gyro sensor.

An eye proximity detection unit 217 detects an eye (object) approaching (eye proximity) or receding (eye separation) with respect to an eyepiece unit 216. The system control unit 201 switches between display (display state) and non-display (non-display state) for the rear display unit 220 and the in-finder display unit 229 according to the state detected by the eye proximity detection unit 217. In a case where at least the shooting mode and the display destination switching is automatic, the system control unit 201 can set the display destination to the rear display unit 220 and the in-finder display unit 229 to non-display while there is no eye proximity. Also, when the eye is in proximity, the display destination is set to the in-finder display unit 229 and the rear display unit 220 is set to non-display.

When an object is in close proximity, infrared light emitted from a light projecting unit (not illustrated) of the eye proximity detection unit 217 reflects and is incident on a light-receiving unit of an infrared proximity sensor. Using the amount of incident light of the infrared light received by the infrared proximity sensor, detections of the approach of a certain object toward the eyepiece unit 216 can be performed and how close the object has come to the eyepiece unit 216 (eye proximity distance) can be determined. When the approach of an object toward the eyepiece unit 216 is detected, the system control unit 201 can start the display of the in-finder display unit 229. Accordingly, display of the in-finder display unit 229 can be performed with as little delay as possible when the user looks into the eyepiece unit 216.

Also, in a case where an object is detected approaching within a predetermined distance of the eyepiece unit 216 from a non-eye proximity state (non-approaching state), the eye proximity detection unit 217 determines that eye proximity has been detected and transmits an eye proximity detection notification to the system control unit 201. Also, in a case where, in the eye proximity state (approaching state), an object detected as approaching moves away a predetermined distance or greater, eye separation is determined, and an eye separation detection notification is transmitted to the system control unit 201. The threshold for detecting eye proximity and the threshold for detecting eye separation may be made different by providing a hysteresis, for example. From when eye proximity is detected until eye separation is detected is determined as an eye proximity state. From when eye separation is detected until eye proximity is detected is determined as a non-eye proximity state. Accordingly, the system control unit 201 performs display control of the rear display unit 220 and the in-finder display unit 229 according to the eye proximity state or the eye separation state detected by the eye proximity detection unit 217.

Note that the eye proximity detection unit 217 is not limited to an infrared proximity sensor and may use another sensor as long as it can detect the approach of an eye or object defined as eye proximity.

A line-of-sight detection unit 260 includes a dichroic mirror 262, an imaging lens 263, a line-of-sight detection sensor 264, a line-of-sight detection circuit 265, and an infrared light-emitting element 266 and detects not only the presence/absence of the line-of-sight of the user but also the position and movement of the line-of-sight.

The camera 200 according to the present embodiment detects a line-of-sight via a method referred to as the corneal reflection method performed by the line-of-sight detection unit 260. The corneal reflection method is a method in which the positional relationship between the reflected light obtained when infrared light emitted from the infrared light-emitting element 266 is reflected at an eyeball (eye) 261 (in particular, the cornea) and the pupil of the eyeball 261 is used to detect the position and the direction of the line-of-sight. Other methods of detecting the position and direction of the line-of-sight include a method called scleral reflection that uses the fact that the reflectance of light is different between the iris and the sclera and the like. Note that a line-of-sight detection method other than that described above may be used as long as the method can detect the position and direction of the line-of-sight.

The infrared light-emitting element 266 is a diode that emits infrared light for detecting the line-of-sight position of the user in the viewfinder screen, and the infrared light is emitted at the central region of the eyepiece unit 216 where the eyeball 261 of the user is located. The infrared light emitted from the infrared light-emitting element 266 is reflected at the eyeball 261, and the reflected infrared light reaches dichroic mirror 262. The dichroic mirror 262 has a function of reflecting only infrared light and allowing visible light to pass, and the reflected infrared light with a changed optical path is focused on an imaging plane of the line-of-sight detection sensor 264 via the imaging lens 263.

The imaging lens 263 is an optical member that constitutes the line-of-sight detection optical system. The line-of-sight detection sensor 264 includes an image sensor such as a CCD, CMOS, or the like. The line-of-sight detection sensor 264 photoelectrically converts the incident reflected infrared light into an electrical signal and outputs this to the line-of-sight detection circuit 265. The line-of-sight detection circuit 265, based on the output signal of the line-of-sight detection sensor 264, detects the line-of-sight position of the user from the movement of the eyeball 261 of the user and the position of the pupil and outputs the detected information to the system control unit 201. The line-of-sight detection sensor 264 can detect the pupil of the eye of the person. Thus, a person's line-of-sight is not detected even if another object approaches or comes into contact with the eyepiece unit 216. Accordingly, the eyepiece unit 216 functions as a line-of-sight operation unit, but the line-of-sight detection unit may have a different configuration. Note that enabling/disabling the line-of-sight input function by the line-of-sight detection unit 260 can be set by the user via a menu screen, for example.

The system control unit 201 can detect the following operations on the eyepiece unit 216 or states based on the detection result of the line-of-sight detection unit 260:

A line-of-sight of the user with an eye close to the eyepiece unit 216 being newly input (detected) (start of line-of-sight input)

A state of the user with an eye close to the eyepiece unit 216 inputting a line-of-sight

A state of the user with an eye close to the eyepiece unit 216 gazing

The line-of-sight input by the user with an eye close to the eyepiece unit 216 being removed (end of line-of-sight input)

A state of the user with an eye close to the eyepiece unit 216 not inputting any line-of-sight

These operations and states and input positions of the line-of-sight with respect to the eyepiece unit 216 are communicated to the system control unit 201, and the system control unit 201 determines what operation (line-of-sight operation) has been performed with respect to the eyepiece unit 216 based on the communicated information.

Note that gaze means that the line-of-sight position of the user does not exceed a predetermined movement amount within a predetermined amount of time. In other words, in a case where a time period in which the line-of-sight of the user is fixed in a region is greater than a predetermined threshold based on detection information received from the line-of-sight detection circuit 265, the system control unit 201 determines this region as being gazed at. Accordingly, this region may be referred to as a position of gaze (gaze region), which is a position being gazed at. Note that “line-of-sight being fixed in a region” refers to, for example, a condition in which the average position of the movement of the line-of-sight remains within the region until a predetermined time period elapses and the variation (variance) is smaller than a predetermined value.

A connection unit 271 is a connector that can electrically connect to an external device. The camera 200 can exchange power and perform data communication with an accessory apparatus or other external device via the connection unit 271.

An operation input unit 270 includes an input interface, such as various types of operation members included in the camera 200, configured to detect an operation input. When an operation input on each input interface is detected, the operation input unit 270 outputs a control signal corresponding to the operation input to the system control unit 201. As described above, in the system according to the present embodiment, the camera 200a and the camera 200b are different in terms of at least one operation member, and there is a difference in the detectable operation input.

### Examples of Various Types of Operation Members

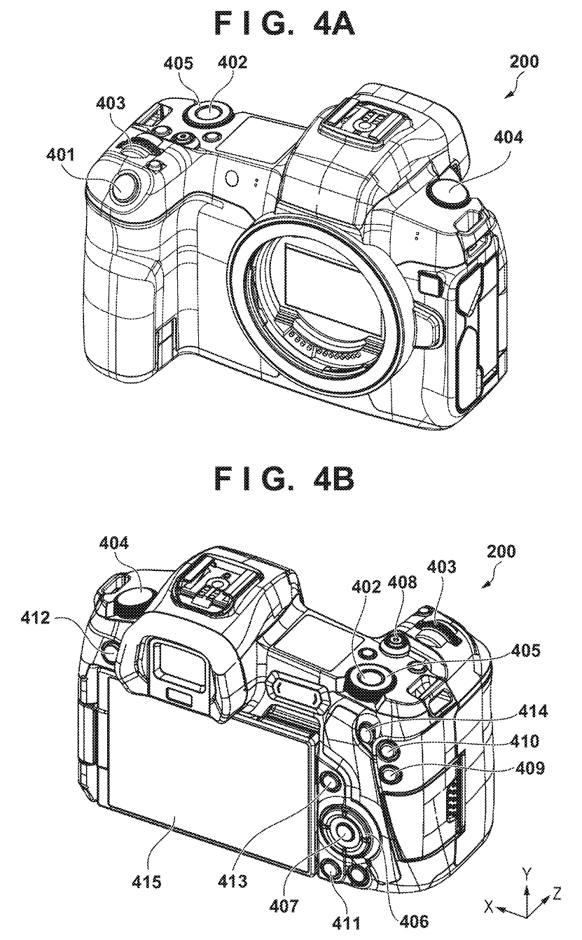

Here, examples of operation members included in the camera 200 will be described with reference to FIGS. 4A and 4B. FIG. 4A is a front perspective view of the camera 200 in a state with the lens unit 290 removed. FIG. 4B is a rear perspective view of the camera 200. FIGS. 4A and 4B illustrate various types of operation members with respect to the external appearance of the camera 200a. However, the camera 200b basically has similar operation members. Hereinafter, in a case where an operation member or structure used in the camera 200a and the camera 200b is different, this will be described in detail.

A shutter button 401 is a push-button operation member for performing an image capture instruction. The shutter button 401 is configured to detect two levels of operation input relating to the press-down amount. When an operation input of putting the shutter button 401 into a half-pressed state is detected, the operation input unit 270 outputs a first shutter button signal SW1 indicating an operation input relating to an image capture preparation instruction. When an operation input of putting the shutter button 401 into a fully-pressed state is detected, the operation input unit 270 outputs a second shutter button signal SW2 indicating an operation input relating to an image capture instruction. When the SW1 is received, the system control unit 201 causes the image processing unit 224 to start AE processing, AF processing, AWB processing, EF processing, and the like. Also, when the SW2 is received, the system control unit 201 starts a sequence of shooting recording processes from reading out a signal from the image capturing unit 222 to writing image data to the storage medium 250.

A mode selection switch 402 is a dial-type operation member for switching the operation mode of the camera 200. The mode selection switch 402 switches the operation mode of the camera 200 to any one of a still image capturing mode, a moving image recording mode, and a playback mode. The still image capturing mode may include, for example, an automatic image capturing mode, an automatic scene determination mode, a manual mode, an aperture priority mode (Av mode), a shutter speed priority mode (Tv mode), and a program AE mode (P mode). The still image capturing mode may also include various types of scene modes, which include image capturing settings specific to respective image capturing scenes, a program AE mode, and custom modes. In a similar manner, the moving image recording mode and the playback mode may include a plurality of operation modes.

A main electronic dial 403 is a rotating-type operation member and is used to change setting values for the shutter speed, the diaphragm, and the like.

A power switch 404 is an operation member for switching the power of the camera 200 on and off.

A sub-electronic dial 405 is a rotating-type operation member for operation input such as moving a selection frame, image scrolling, and the like.

The camera 200 includes a grip allowing the user to grip the camera 200 with the little finger, ring finger, and the middle finger. The shutter button 401 and the main electronic dial 403 are disposed at a position where they can be operated with the index finger of the right hand when the camera 200 is in a gripped state. In a similar manner, the sub-electronic dial 405 is disposed at a position where it can be operated with the thumb of the right hand when the camera 200 is in a gripped state.

A four-direction key 406 is an operation member that enables operation input indicating a direction corresponding to the pressed portion of the four-direction key 406 via one of the four directions, up, down, left, and right, being pressed.

A SET button 407 is a push-button type operation member used mainly to set the selection item.

A record button 408 is a push-button operation member used to switch the live view display on and off in the still image capturing mode and to instruct to start and stop moving image shooting (recording) in the moving image recording mode.

An enlarge button 409 is a push-button operation member used to turn enlarged display on and off during live view and to change the magnification ratio of the displayed enlarged display. Also, the enlarge button 409 is used to enlarge the playback image in the playback mode and increase the magnification ratio. Also, enlarging or shrinking of the live view may be made to be performable by the main electronic dial 403 being operated after the enlarged display is turned on. The enlarge button 409 functions as an enlarge button to enlarge the playback image in the playback mode and to increase the magnification ratio.

An AE lock button 410 is a push-button operation member that enables the exposure state to be locked by being pressed in a shooting standby state.

A playback button 411 is a push-button operation member used to switch between the shooting mode and the playback mode. When an operation input of pressing the playback button 411 is performed during the shooting mode, the mode transitions to the playback mode and the latest image of the images stored in the storage medium 250 is displayed on the rear display unit 220, for example.

A menu button 412 is a push-button operation member for displaying a menu screen for settings relating to the various types of operation modes on the rear display unit 220. While the menu screen is displayed, the user can intuitively set various types of settings using the four-direction key 406, the SET button 407 or a multi-controller 413.

The multi-controller 413 is an operation member configured to detect two types of operation input: a pressing operation input and a tilt operation input in the circumferential direction. The multi-controller 413 can separately detect eight types of circumferential directions for the tilted direction and can detect these as an operation input designating one of the eight directions. Using the multi-controller 413 makes it easy to change the selection item in the menu screen, move the enlarged display position in the playback mode, change various types of shooting parameters, and the like.

An AF on button 414 is a push-button operation member configured to detect an operation input relating to an AF control instruction. The AF on button 414 is an aspect of an input interface in which the operation member is of a different type between the camera 200a and the camera 200b. In the present embodiment, in the camera 200a, the AF on button 414 is configured to detect two levels of operation input relating to the press-down amount. In the camera 200b, the AF on button 414 is configured to detect one level of operation input, that is, whether it is pressed or not.

When an operation input of putting the AF on button 414 into a half-pressed state is detected, the operation input unit 270 of the camera 200a outputs a first AF on signal SW3. Also, when an operation input of putting the AF on button 414 into a fully-pressed state is detected, the operation input unit 270 of the camera 200a outputs a second AF on signal SW4. In one aspect, the AF on button 414 is used for receiving an operation input for instructing to start or stop photometry and AF. When the SW3 is received, the system control unit 201 of the camera 200a starts photometry and AF processing, and when the SW4 is received, the system control unit 201 of the camera 200a stops AF. On the other hand, when an operation input on the AF on button 414 independent of the press-down amount is detected, the operation input unit 270 of the camera 200b outputs a control signal indicating this. In one aspect, when a control signal in response to an operation input on the AF on button 414 is received, the operation input unit 270 of the camera 200b starts photometry and AF processing.

Also, in a case where the rear display unit 220 is configured to detect a touch operation, the operation input unit 270 also detects a touch operation on a touch panel 415 provided on the rear display unit 220. The touch panel 415 and the rear display unit 220 are integrally formed. For example, the touch panel 415 is configured to have light transmittance that does not obstruct the display of the rear display unit 220 and is attached to the upper layer of the display surface of the rear display unit 220. Also, the input coordinates in the touch panel 415 are associated with the display coordinates of the rear display unit 220. In this manner, a GUI can be provided that simulates a user being able to directly operate a screen displayed on the rear display unit 220. The system control unit 201 can detect the following operations and states with respect to the touch panel 415.

· A finger or stylus pen that has not touched the touch panel 415 newly touching the touch panel 415. In other words, touch start (referred to as touch-down below).

· A state of the finger or stylus pen touching the touch panel 415 (referred to as touch-on below).

· A state of the finger or stylus pen moving while touching the touch panel 415 (referred to as touch-move below).

· The finger or stylus pen touching the touch panel 415 being separated. In other words, touch end (referred to as touch-up below).

· A state of nothing touching the touch panel 415 (referred to as touch-off below).

When touch-down is detected, touch-on may also be simultaneously detected. After, a touch-down, for as long as a touch-up is not detected, a touch-on is typically continuously detected. Touch-move is also detected while touch-on is being detected. Even, if a touch-on has been detected, unless the touch position is moving, a touch-move is not detected. A touch-off correlates to after the detection of touch-up of all of the fingers and stylus pen that were touching.

These operations and state and positional coordinates where a finger or stylus pen is touching the touch panel 415 are communicated to the system control unit 201 via the internal bus 120 by the operation input unit 270. The system control unit 201 determines which operation (touch operation) was performed on the touch panel 415 based on the communicated information.

Regarding touch-move, the movement direction of the finger or stylus pen moving on the touch panel 415 can be detected. The movement direction can be determined for each vertical component and horizontal component of the touch panel 415 based on changes in the positional coordinates. In a case where a touch-move of a predetermined distance or greater is detected, it is determined that a slide operation (drag) has been performed. An operation where a finger, while touching the touch panel 415, is quickly moved a certain distance and then released is referred to as a “flick”. In other words, a flick is an operation of quickly drawing a finger across the touch panel 415 then releasing. In a case where a touch-move of a predetermined distance or greater at a predetermined speed or greater is detected and then touch-up is detected, a flick may be determined to have been performed (it can be determined that a flick was performed after a drag). Furthermore, a touch operation of touching a plurality of points (e.g. two points) simultaneously and moving these touch positions closer together is referred to as “pinch-in”, and a touch operation of moving these touch positions further apart is referred to as “pinch-out”. Pinch-out and pinch-in are collectively referred to as a pinch operation (or simply “pinch”).

For the touch panel 415, various types of touch panels may be used, such as a resistive film type, an electrostatic capacitance type, a surface acoustic wave type, an infrared type, an electromagnetic induction type, an image recognition type, and an optical sensor type. In other words, the touch panel 415 may use any method including a method in which a touch is detected in a case where the touch panel is touched and a method in which a touch is detected in a case where a finger or stylus pen approaches the touch panel.

### Change of Function Allocation to Operation Member

Each operation member described above is configured to invoke a default function preset for the operation member at the time that the camera 200 is shipped. However, there are cases where it is preferable that at least one operation member is configured to be able to invoke a function different from the default function in order for the camera 200 to be used efficiently, for example, such as in a case where how the camera 200 is used is different depending on the user.

Thus, in the system according to the present embodiment described above, the camera 200 is configured in a manner such that a function allocated to an operation member can be changed (customized). Changing a function allocation may be implemented by selecting a menu relating to function allocation change from the menu screen on the camera 200, selecting the target operation members in order, and designating and saving the function allocated to each operation member. In the present embodiment, allocating a function to an operation member is described as being able to be set per operation mode of the camera 200. In other words, for one operation member, different functions can be allocated for each operation mode.

The operation member which can have its function allocation changed is not necessarily all of the operation members included in the camera 200, and this may be restricted to one or more operation members. Alternatively, a configuration may be used in which the function allocated to one or more level of operation input can be changed, and the function allocated to another level of operation input cannot be changed. For example, in the operation mode for shooting, shooting can be made to always be performed with the shutter button 401 in the fully-pressed state using a configuration in which an operation input relating to shooting start is able to be received but function allocation is unable to be changed. However, for the half-pressed state of the shutter button 401, the function allocation can be changed. To facilitate understanding of the technology, hereinafter, the term operation member will be used to refer to an operation member which can have its function allocation changed, and operation members that cannot have their function allocation changed will be excluded from the description.

In the camera 200 according to the present embodiment, the allocation of the function for at least the AF on button 414 is configured to be able to be changed, and the user can change the function allocated to the AF on button 414 using the camera 200a or the camera 200b. In other words, with the camera 200a, the user can allocate a function selected from settable functions for two levels of operation input (half-press operation and full-press operation) of the AF on button 414. Also, with the camera 200b, the user can allocate one function selected from the settable functions for the AF on button 414. In other words, for the AF on button 414, two types of functions can be allocated in the camera 200a and one type of function can be allocated in the camera 200b.

### Overview of Carry-over of Function Allocation Settings

Being able to change the function allocated to an operation member set separately in each camera 200 increases the ease-of-use for the user. Thus, preferably, the user can use another camera 200 while using similar settings. In other words, when a user that used the camera 200a uses the camera 200b, by allocating a similar function as in the camera 200a to the operation member located at a corresponding position, similar ease-of-use with the camera 200b can be implemented. However, with the camera 200b, forcing the user to change the function allocation of each operation member to obtain a similar ease-of-use to that of the camera 200a each time is not realistic. In particular, for a user that borrows one camera 200 to use from among a plurality of cameras owned by a business for each task, there is no guarantee that the camera 200 they used last time can be used the next time, and having to change the function allocation each time is inconvenient.

Thus, with the system according to the present embodiment, the smartphone 100 is provided with which the settings relating to changing the function allocation to the operation member used with the camera 200a are carried over to the camera 200b. In other words, the smartphone 100 obtains information (hereinafter referred to as setting information) indicating the allocation of a function to an operation member of the camera 200a from the carry-over source camera 200a and performs allocation of the function to the operation member of the camera 200b based on the setting information. In this manner, the user can complete function allocation to various types of operation members of the camera 200b to implement a similar operation feeling without performing a setting operation for the camera 200b relating to changing the function allocation to each operation member to obtain an operation feeling similar to that of the camera 200a.

### Setting Information

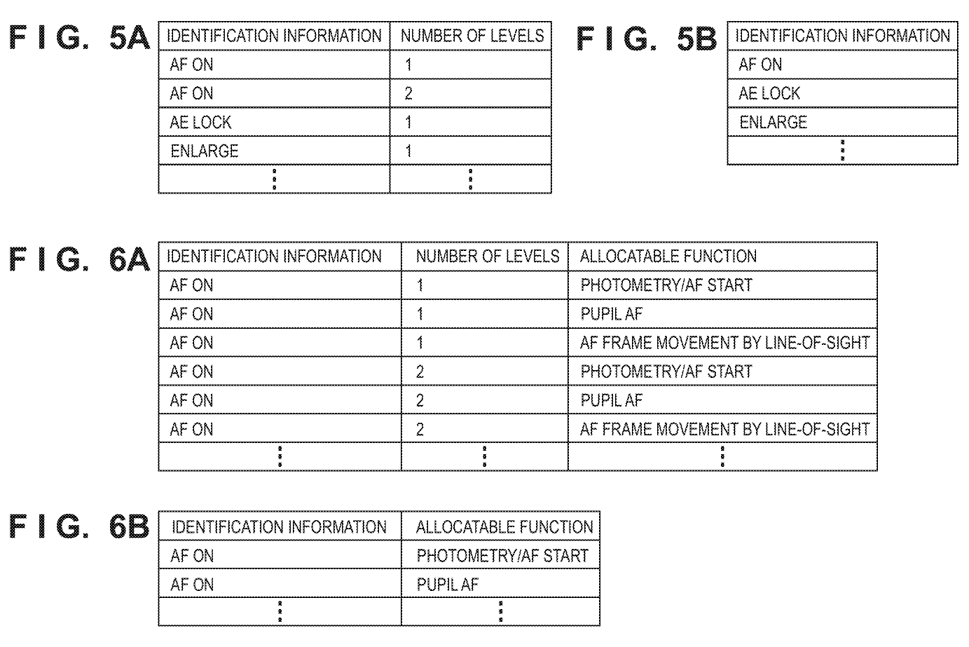

In one aspect, the setting information includes, for each of the operation members included in each camera 200, member information describing identification information for uniquely identifying the operation member and information of the number of levels that can be detected for an operation input to the operation member. The member information may be configured for the camera 200a as illustrated in FIG. 5A and may be configured for the camera 200b as illustrated in FIG. 5B, for example. The operation member with information included in member information is limited to an operation member configured to be able to have its function allocation changed.

In the present embodiment, the operation members included in the camera 200b are each configured to detect only one level of operation input. Thus, the operation member illustrated in FIG. 5B does not include information of the number of levels that can be detected for an operation input. In such a case where the member information does not include information of the number of levels, it can be understood that each operation member has one level for the number of levels that can be detected for an operation input. However, the AF on button 414 from among the operation members included in the camera 200a is configured to detect two levels of operation input. Thus, in the member information illustrated in FIG. 5A, for the operation member with “AF on” for the identification information (operation member name), there are two types of levels, a first level and a second level. This indicates that the AF on button 414 detects two levels of operation input.

Also, the setting information includes function candidate information listing the functions that can be allocated to each operation member. The function candidate information may be configured for the camera 200a as illustrated in FIG. 6A and may be configured for the camera 200b as illustrated in FIG. 6B, for example. As illustrated in FIG. 6A, for the AF on button 414 of the camera 200a, a function that can be invoked when a first level operation input (half-press operation) is detected and a function that can be invoked when a second level operation input (full-press operation) is detected are defined. Also, as illustrated in FIG. 6B, for the AF on button 414 of the camera 200b, a function that can be invoked when a (first level) operation input is detected is defined. Note that the function candidate information includes functions allocated by default to operation members from among the functions listed in the information, or in other words information of the functions (functions allocated via initial settings) allocated at the time of shipping of the camera 200.

The member information and the function candidate information are pieces of information that are uniquely determined by the model of the camera 200 being set and do not change at any point in time. In other words, the member information is information indicating what operation members the camera 200 includes, the function candidate information is information indicating what functions can be allocated to the operation member in the camera 200, and both are immutable information. These pieces of information are, for example, stored in the non-volatile memory 256 of each camera 200 and may be configured to be obtainable by the smartphone 100 via a communication connection or may be configured to be stored in advance inside the smartphone 100.

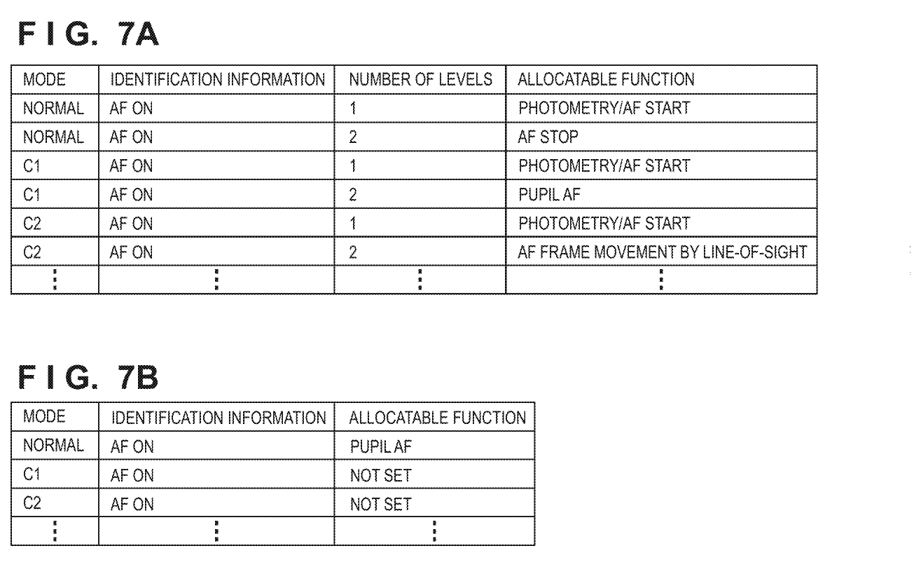

However, the information of a function allocated to an operation member is information that can be changed by the user or the like using the camera 200. Thus, the setting information further includes allocation information indicating the functions allocated to each of the operation members. The camera 200 according to the present embodiment is configured so that a function can be allocated to each operation member per operation mode. Thus, the allocation information defines the function allocated to each operation member per operation mode as illustrated in FIGS. 7A and 7B.

FIG. 7A illustrates allocation information indicating allocation of functions to the operation members of the camera 200a. FIG. 7B illustrates allocation information indicating allocation of functions to the operation members of the camera 200b. As illustrated in FIG. 7A, the allocation information relating to the camera 200a includes the operation mode, the identification information of the operation member and the information (number of levels) identifying what levels of operation input there are for the operation member associated together and defines information of the allocated functions. In the example of FIG. 7A, for the AF on button 414 in the normal mode, the C1 mode, and the C2 mode, the function allocated to each operation input for the first level and the second level is defined. Hereinafter, for an operation member such as the AF on button 414 that can detect two levels of operation input, the function allocated to the first level operation input (half-press operation) is referred to as a first function and the function allocated to the second level operation input (full-press operation) is referred to as a second function.

As illustrated in FIG. 7B, the allocation information relating to the camera 200b includes the operation mode and the identification information of the operation member associated together and defines the information of the allocated functions. In a difference from FIG. 7A, in the allocation information relating to the camera 200b, information designating levels for an operation input for invoking a function allocated to the AF on button 414 is not included.

Note that the allocation information illustrated in FIGS. 7A and 7B is an excerpted display of mainly only the information relating to function allocation to the AF on button 414. However, the embodiments of the present technology are not limited thereto. The allocation information may of course include information relating to the function allocation to another operation member.

### Carry-over for Operation Members with Different Detectable Number of Levels

In the system according to the present embodiment as illustrated in FIGS. 5A and 5B, the AF on button 414 included in the camera 200a and the AF on button 414 included in the camera 200b have a different detectable number of levels for an operation input. Specifically, the AF on button 414 of the camera 200a is configured to detect two levels of an operation input, but the AF on button 414 of the camera 200b is configured to detect only one level of operation input. In this case, the function allocated to the operation member cannot be carried over as is. In other words, since the detectable number of levels for an operation input is different between the carry-over source (camera 200a) and the carry-over destination (camera 200b), a function allocation that can guarantee an operation feeling similar to that of the carry-over source cannot be implemented.

Thus, in the smartphone 100 according to the present embodiment, when executing processing (hereinafter, also referred to as carry-over processing) relating to carry-over of function allocation settings, a determination is performed for whether or not the number of levels for an operation input that can be detected is the same across operation members corresponding to the carry-over source and the carry-over destination. In a case where it is determined that the number of levels for an operation input that can be detected is different across corresponding operation members, one of the functions from among the two functions (first function, second function) allocated to the carry-over source operation member is determined as the function to be allocated to the operation member of the carry-over destination. Since the number of levels that can be detected is different between the AF on button 414 of the carry-over source and the carry-over destination in the examples of FIGS. 5A and 5B, the function allocated to the AF on button 414 of the camera 200b is selected from the functions allocated to the AF on button 414 of the camera 200a.

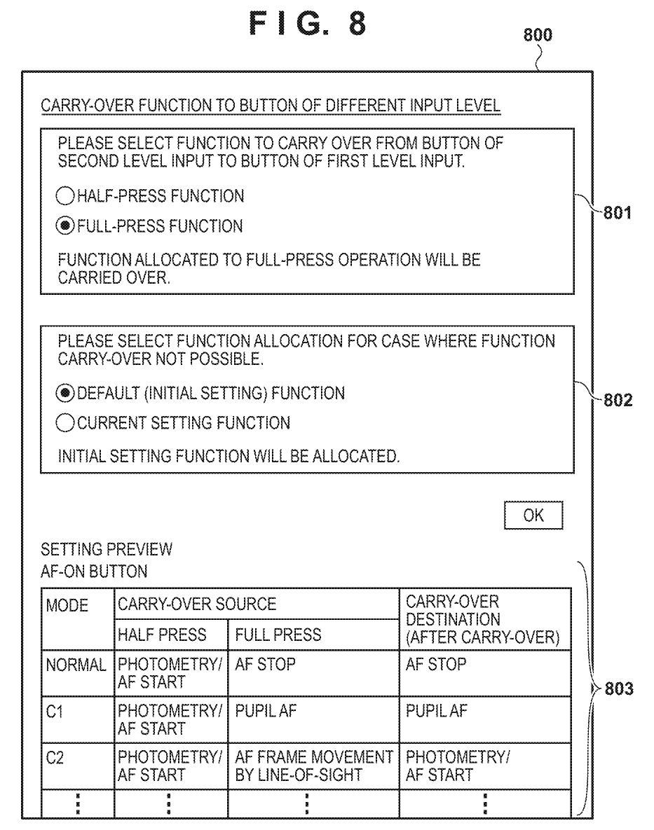

In one aspect, the function allocated to the operation member of the corresponding carry-over destination may be selected based on the information of predetermined carry-over settings from the operation members of the carry-over source that can detect two levels of an operation input. The carry-over settings may be set on the smartphone 100 via a carry-over settings screen (GUI) 800 such as that illustrated in FIG. 8, for example.

In the example of FIG. 8, the carry-over settings screen 800 is configured to allow the user to designate how to perform carry-over of function allocation settings for an operation member of the carry-over source that can detect two levels of an operation input to a corresponding operation member of the carry-over destination that can detect one level of operation input. Specifically, in the case of carry-over of function allocation settings for an operation member with such a relationship, the carry-over settings screen 800 includes a setting item 801 for designating which level of operation input for invoking a function to allocate to the operation member of the carry-over destination. In the setting item 801 of the illustrated example, in a case where the carry-over destination operation member is configured to detect only one level for an operation input, the user can designate whether to carry over the function allocated to the first level operation input (half-press operation) or the function allocated to the second level operation input (full-press operation) of the same carry-over source operation member. In other words, in the setting item 801, a selection rule can be set relating to whether to select the first function or the second function relating to the carry-over source operation member as the function to allocate to the carry-over destination operation member.

Also, as illustrated in FIGS. 4A and 4B, the functions that can be allocated to each operation member may be different according to the model of the camera 200. Thus, even if a function to be allocated to an operation member of the carry-over destination is determined based on the carry-over settings designated via the setting item 801, that function may be unable to be allocated to an operation member of the carry-over destination. Accordingly, the carry-over settings screen 800 includes a setting item 802 for designating a function to be allocated to an operation member of the carry-over destination for a case where the function designated in the setting item 801 cannot be allocated (cannot be carried over). In the setting item 802 of the illustrated example, in a case where carry-over based on the carry-over settings is impossible, whether to allocate the function allocated by default to the carry-over destination operation member or whether to maintain (not change allocation) the function allocated at the present time to the operation member can be designated.

Input of the carry-over settings via the carry-over settings screen 800 may be performed before the carry-over processing is executed. In an alternative configuration, the carry-over settings screen 800 may be displayed in a case where there are operation members with different number of levels for an operation input that can be detected during execution of the processing, and the user can input the carry-over settings. In the latter case, the carry-over settings screen 800 may include a settings preview 803 indicating which functions are set via the options of the setting items 801 and 802.

In the example of FIG. 8, in the settings preview 803, the functions of “AF stop” and “Pupil AF”, which are functions allocated to a full-press operation of the AF on button 414, are allocated in normal mode and C1 mode. However, in the C2 mode, since the function of “AF frame movement via line-of-sight” is not included as a function that can be allocated to the AF on button 414 in the carry-over destination camera 200b, the function of “Photometry/AF start”, which is the initial setting, is allocated. Note that in the example of FIG. 8, the function allocated to the carry-over destination operation member is displayed by the settings preview 803 after the carry-over, but the settings preview 803 may further include a function allocated to the operation member before the carry-over.

In this manner, in the smartphone 100 according to the present embodiment, by executing the carry-over processing, the function allocation settings can be favorably carried over to the operation member of the camera 200b, which is the carry-over destination, based on the setting information of the camera 200a and the carry-over settings information.

### Carry-over Processing

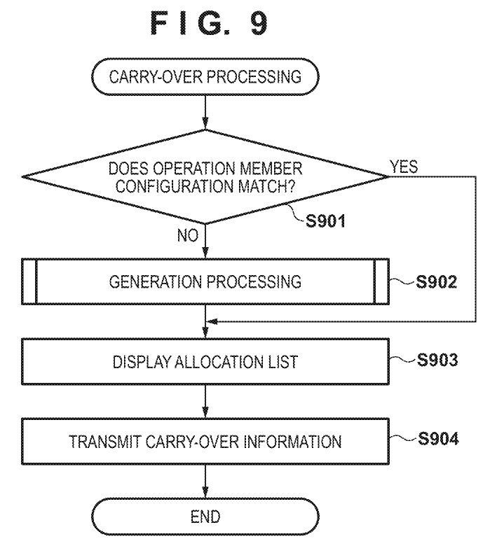

Carry-over processing executed in the smartphone 100 according to the present embodiment with such a configuration will now be described in detail using the flowchart of FIG. 9. The processing corresponding to the flowchart can be implemented by the CPU 101 reading out the corresponding processing programs stored in the non-volatile memory 103, for example, loading them into the memory 102, and executing them. The carry-over processing described herein is started when the carry-over source camera (camera 200a) and the carry-over destination camera (camera 200b) are designated in the smartphone 100 and an operation input relating to an instruction to carry over the function allocation settings is detected, for example.

Note that in the present embodiment described herein, setting information relating to the carry-over source camera and setting information relating to the carry-over destination camera are obtained before execution of the carry-over processing and stored in a storage apparatus such as the memory 102, the non-volatile memory 103, the storage medium 108, or the like. However, the present technology is not limited thereto, and in a case where a camera with unobtained setting information is selected as the carry-over source or the carry-over destination, the CPU 101 may perform control to connect to the camera so as to communicate with it and receive the setting information. Also described herein, the carry-over settings are set before execution of the carry-over processing, and that information is stored in a storage apparatus such as the memory 102, the non-volatile memory 103, the storage medium 108, or the like.

In S901, the CPU 101 determines whether or not the configurations of the operation members match between the carry-over source camera and the carry-over destination camera. The determination of the present step may be performed by comparing the member information included in the setting information of each camera. Here, the configurations of the operation members matching means that the identification information (name) of the operation member and the number of levels for an operation input that can be detected for the operation member are the same for the operation members corresponding to the carry-over source camera and the carry-over destination camera. The configurations of the operation members matching may occur not only when the carry-over source and the carry-over destination are cameras of the same model but also when successive models, similar models, or the like include similar operation members. In a case where the CPU 101 determines that the configurations of the operation members match between the carry-over source camera and the carry-over destination camera, the CPU 101 advances the processing to S903, and in a case where the CPU 101 determines that they do not match, the CPU 101 advances the processing to S902.

In S902, the CPU 101 executes generation processing to generate allocation information from the allocation information relating to the carry-over source camera to be applied to the carry-over destination camera in order to carry-over the function allocation settings between the cameras with different operation member configurations. In the generation processing according to the present embodiment described here, the CPU 101 generates allocation information to be applied to the carry-over destination camera based on the allocation information relating to the carry-over source camera obtained before execution of the carry-over processing and allocation information relating to the carry-over destination camera. Hereinafter, to distinguish between the pieces of allocation information, the allocation information relating to the carry-over source camera obtained before the execution of the carry-over processing will be referred to as “first allocation information”, and the allocation information relating to the carry-over destination camera will be referred to as “second allocation information”. Also, the allocation information to be applied to the carry-over destination camera that is generated by the generation processing will be referred to as “carry-over information”.

Note that to facilitate understanding of the technology, in the present embodiment described here, the allocation of a function to an operation member is performed for all of the operation modes of the carry-over source camera. In other words, the first allocation information includes information of which function is invoked by an operation input of each operation member for all of the operation modes.

### Generation Processing

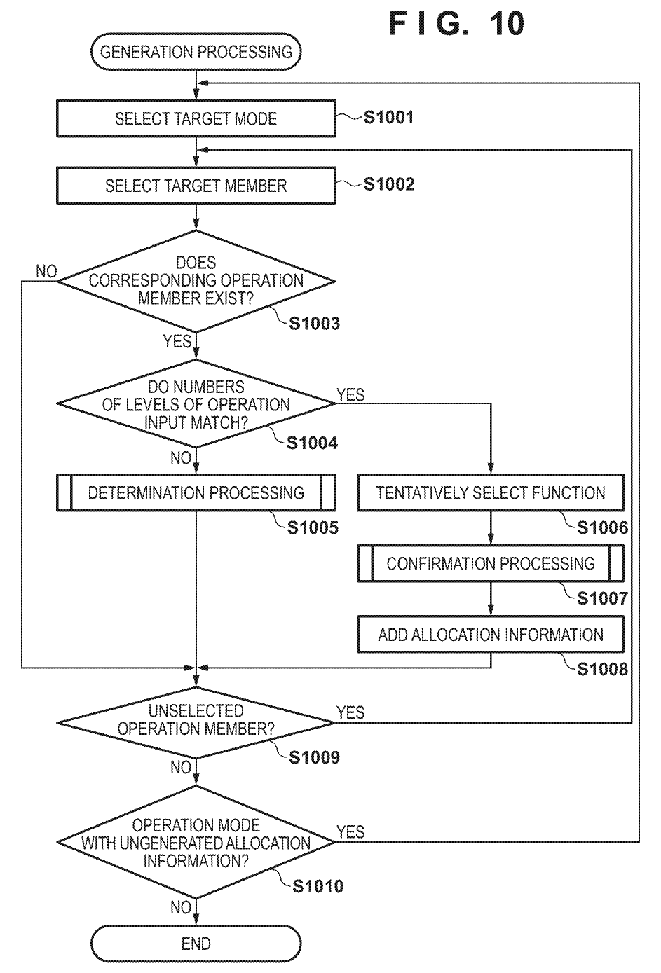

Here, the generation processing of the carry-over information executed in the present step will be described in detail with reference to the flowchart of FIG. 10.

In S1001, the CPU 101 selects, from among the operation modes included in the carry-over source camera, an operation mode without generated allocation information to be included in the carry-over information as the target mode. In the processing described below, the carry-over information is generated by repeatedly adding allocation information relating to the operation mode relating to the carry-over destination while successively changing the target mode relating to the carry-over source camera.

In S1002, for the target mode, the CPU 101 selects an unselected operation member as a target member from among the operation members specified in the first allocation information.

In S1003, the CPU 101 determines whether or not the operation member (hereinafter, also referred to as a corresponding operation member) corresponding to the target member exists in the carry-over destination camera. In a case where the CPU 101 determines that the corresponding operation member exists, the CPU 101 advances the processing to S1004, and in a case where the CPU 101 determines that it does not exist, the CPU 101 advances the processing to S1009.

In S1004, the CPU 101 determines whether or not the number of levels for an operation input that can be detected by the target member matches the number of levels for an operation input that can be detected by the corresponding operation member. In a case where the CPU 101 determines that the number of levels for the operation input that can be detected by the target member matches the number of levels for the operation input that can be detected by the corresponding operation member, the CPU 101 advances the processing to S1006, and in a case where the CPU 101 determines that they do not match, the CPU 101 advances the processing to S1005.

In S1005, the CPU 101 executes determination processing to determine the function to allocate to the corresponding operation member for the target mode. In other words, the CPU 101 executes determination processing according to the present embodiment in order to determine the function allocation to be carried over to the corresponding operation member that can detect one level for the operation input from the target member that can detect two levels for the operation input.

### Determination Processing

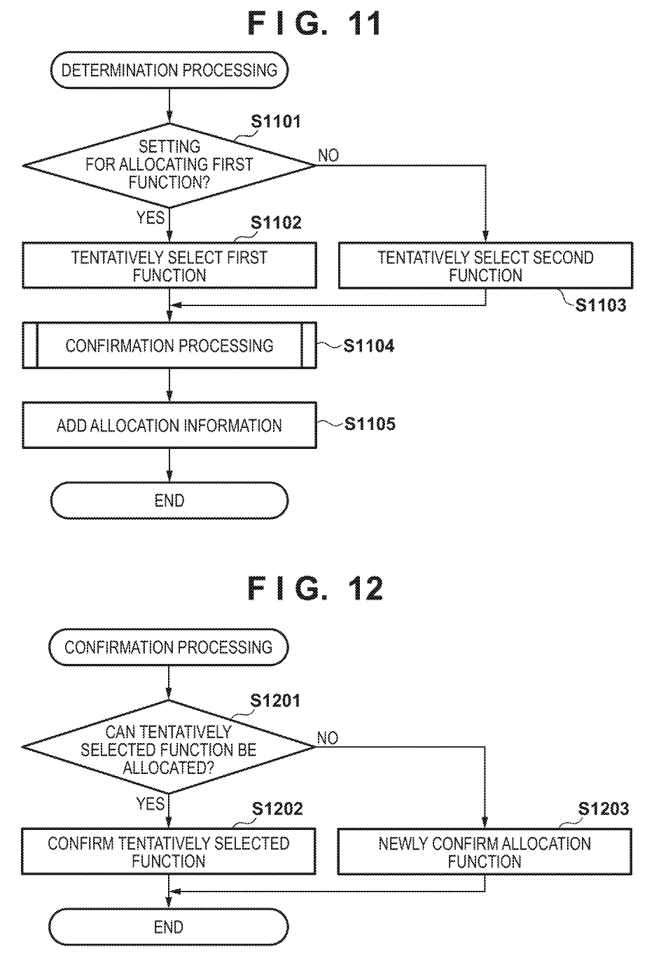

Here, the determination processing executed in the present step will be described in detail with reference to the flowchart of FIG. 11.

In S1101, the CPU 101 determines whether or not allocation of the first function has been set in the carry-over settings. In a case where the CPU 101 determines that allocation of the first function has been set in the carry-over settings, the CPU 101 advances the processing to S1102, and in a case where the CPU 101 determines that it has not been set, that is, that allocation of the second function has been set, the CPU 101 advances the processing to S1103.

In S1102, the CPU 101 tentatively selects, as the function to be allocated to the corresponding operation member of the target mode, the first function allocated to the target member of the same target mode. In other words, the CPU 101 tentatively selects the function (first function) allocated to be invoked for the target mode when a first level operation input to the target member is detected as the candidate for the function to be invoked when an operation input to the corresponding operation member is detected.

On the other hand, in a case where the CPU 101 determines that allocation of the first function has not been set in S1101, in S1103, the CPU 101 tentatively selects, as the function to be allocated to the corresponding operation member of the target mode, the second function allocated to the target member of the same target mode. In other words, the CPU 101 tentatively selects the function (second function) allocated to be invoked for the target mode when a second level operation input to the target member is detected as the candidate for the function to be invoked when an operation input to the corresponding operation member is detected.

In S1104, the CPU 101 executes confirmation processing to finally confirm the function allocated to the corresponding operation member of the target mode.

### Confirmation Processing

The confirmation processing executed in the present step will now be described with reference to the flowchart of FIG. 12.

In S1201, the CPU 101 determines whether or not the function allocated to the corresponding operation member of the target mode that is tentatively selected can be allocated to the corresponding operation member. The determination of the present step can be performed based on the function candidate information relating to the corresponding operation member. In a case where the CPU 101 determines that the tentatively selected function can be allocated to the corresponding operation member, the CPU 101 advances the processing to S1202, and in a case where the CPU 101 determines that it cannot be allocated, the CPU 101 advances the processing to S1203.

In S1202, the CPU 101 confirms the tentatively selected function as the function allocated to the corresponding operation member of the target mode and ends the present confirmation processing.

On the other hand, in a case where the CPU 101 determines that the tentatively selected function cannot be allocated to the corresponding operation member in S1201, in S1203, the CPU 101 confirms a function to be allocated to the corresponding operation member of the target mode and ends the present confirmation processing. The function confirmed at this time is determined based on the settings in the setting item 802 of the carry-over settings screen 800, for example, and is not determined based on the first allocation information relating to the target member of the target mode. In the example illustrated in FIG. 8, the CPU 101 confirms either the function allocated by default to the corresponding operation member or function currently allocated to the corresponding operation member as the function to be allocated to the corresponding operation member of the target mode.

When the confirmation processing ends in this manner, the CPU 101 advances the determination processing to S1105.

In S1105, for the corresponding operation member of the target mode, the CPU 101 adds the allocation information including the information of the function confirmed as a result of the confirmation processing to the carry-over information and ends the present determination processing.

When the determination processing ends, the CPU 101 advances the generation processing to S1009.

On the other hand, in a case where the CPU 101 determines that the number of levels for an operation input that can be detected matches between the target member and the corresponding operation member in S1004, in S1006, the CPU 101 tentatively selects, as the function to be allocated to the corresponding operation member of the target mode, the function allocated to the target member of the same mode. At this time, in a case where both the target member and the corresponding operation member can detect two levels of an operation input, the CPU 101 tentatively selects the first function relating to the target member for the first level operation input of the corresponding operation member and the second function relating to the target member for the second level operation input.

In S1007, the CPU 101 executes confirmation processing based on the tentatively selected function for the corresponding operation member in S1006. In a case where, as a result of the confirmation processing, the function allocated to the target member of the target mode can also be allocated to the corresponding operation member, function allocation can be implemented that guarantees operation feeling for the corresponding operation member of the target mode that is the same as the operation feeling for the target member.

In S1008, for the corresponding operation member of the target mode, the CPU 101 adds the allocation information including the information of the function confirmed as a result of the confirmation processing to the carry-over information and advances the processing to S1009.

In S1009, for the target mode, the CPU 101 determines whether or not an operation member that is unselected as the target member exists from among the operation members specified in the first allocation information. In a case where the CPU 101 determines that an operation member that is unselected as the target member exists, the CPU 101 returns the processing to S1002, and in a case where the CPU 101 determines that it does not exist, the CPU 101 advances the processing to S1010.

In S1010, the CPU 101 determines whether or not an operation mode with ungenerated allocation information exists from among the operation modes included in the carry-over source camera. In a case where the CPU 101 determines that an operation mode with ungenerated allocation information exists, the CPU 101 ends the present generation processing, and in a case where the CPU 101 determines that it does not exist, the CPU 101 returns the processing to S1001.

When the generation processing ends in this manner, in S903 of the carry-over processing, the CPU 101 displays a list of functions allocated to the operation members of the carry-over destination camera based on the generated carry-over information on the display 105 for the user to confirm. With the list display, individual allocation changes by the user may be received, for example. In this case, the corresponding allocation information of the carry-over information is changed based on an operation input by the user. When an operation input relating to user confirmation is detected, the CPU 101 advances the processing to S904.

In S904, the CPU 101 transmits the carry-over information to the carry-over destination camera together with the function allocation change instruction and ends the present carry-over processing. At this time, in a case where a communication connection between the smartphone 100 and the carry-over destination camera (camera 200b) is not established, the CPU 101 executes processing to establish a communication connection. Also, the CPU 101 can execute processing to convert the carry-over information into a format supported by the function allocation settings processing for the carry-over destination camera as necessary. When the carry-over information is received together with the function allocation change instruction, the system control unit 201 of the carry-over destination camera executes function allocation setting processing. In this manner, allocation of functions invoked when an operation input to each operation member is detected in each operation mode set in the carry-over settings for the carry-over destination camera is implemented.

As described above, according to the information processing apparatus according to the present embodiment, allocation of functions to operation members across electronic devices including operation members with different numbers of levels for an operation input that can be detected can be favorably implemented.

### Modification Example 1

In the embodiment described above, in a case where the carry-over source operation member is configured to detect two levels of an operation input, a function (the first function or the second function) designated in the carry-over settings screen 800 is fixedly selected and carried over to the corresponding operation member of the carry-over destination. However, the present technology is not limited to this, and which function, from among the functions allocated to each of the operation inputs with two levels, to be carried over may be selected via different criteria.

Selecting a function to be carried over may be performed by referencing user-specific information such as the use frequency (invoke frequency) of the function in the carry-over source camera, for example. In this case, the information of the use frequency of each function of the user is obtained as the setting information, for example, and the CPU 101 selects the function with the highest use frequency as the function to be carried over. Alternatively, in a case where the functions allocated to each of the operation inputs with two levels include a function with confirmed allocation to another operation member in the carry-over destination camera, the other function may be selected as the function to be carried over.

In this manner, the carry-over settings for which function, from among the functions allocated to each of the operation inputs with two levels, to be carried over can be adaptively selected and is not limited to being set by the user. Note that in this case, options, such as in the setting item 801 of the carry-over settings screen 800, for selecting for which operation input of the corresponding operation member of the carry-over destination to carry over the function may not be displayed, and the settings preview 803 corresponding to the carry-over destination may be displayed without user selection.

### Modification Example 2

In the embodiment described above, for an operation member that can detect two levels of an operation input included in the carry-over source camera, one function from among the first function and the second function allocated to the first and second level operation input is allocated to the operation member of the carry-over destination based on the carry-over settings. However, the present technology is not limited thereto, and at least one of the two levels of operation input that can be detected by the operation member may not be allocated with a function to invoke, that is, may have function invoking disabled.

However, in a case where function invoking is disabled for an operation member of the carry-over source in this manner, there is a possibility that the user convenience may be reduced by putting the corresponding operation member of the carry-over destination in a similar function invoking disabled state. In particular, in an aspect in which one of two levels of operation input has function invoking enabled (a function is allocated) but the other has function invoking disabled, from the perspective of making a variety of operation inputs possible, preferably, function invoking is also enabled for the corresponding operation member of the carry-over destination. Thus, in the smartphone 100 according to the present modification example, in the determination processing to determine function allocation to carry over to the corresponding operation member that can detect one level for the operation input from the target member that can detect two levels for the operation input, different control is performed depending on whether or not function invoking is disabled.

### Determination Processing

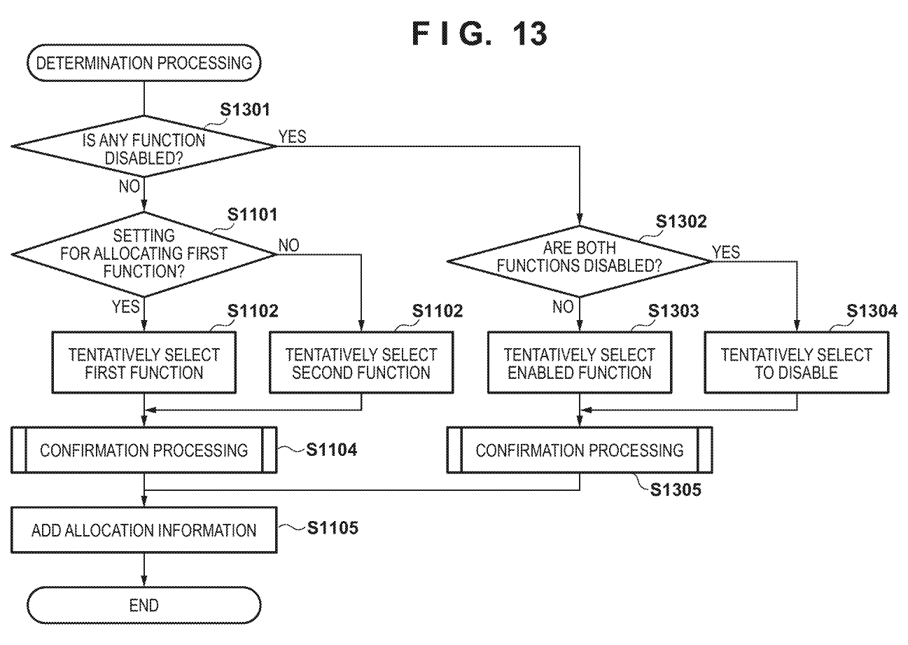

The determination processing executed in the smartphone 100 according to the present modification example will be described below in detail with reference to the flowchart of FIG. 13. Note that in the description of the determination processing according to the present modification example, steps in which processing is executed that is similar to the determination processing of the first embodiment will be given the same reference number and will not be described. Mainly, only processing specific to the present modification example will be described below.

In S1301, the CPU 101 determines whether or not function invoking is disabled for at least one of the two levels of operation inputs that can be detected by the target member of the target mode. In other words, the CPU 101 determines whether at least one of the first function and the second function has an unallocated status for the target member of the target mode. In a case where the CPU 101 determines that at least one of the two levels of operation input that can be detected by the target member has function invoking disabled, the CPU 101 advances the processing to S1302. In a case where the CPU 101 determines that at least one of the two levels of operation input that can be detected by the target member does not have function invoking disabled, that is, function invoking is enabled, the CPU 101 advances the processing to S1101.

In S1302, the CPU 101 determines whether or not function invoking is disabled for both of the two levels of operation inputs that can be detected by the target member of the target mode. In other words, the CPU 101 determines whether both the first function and the second function have an unallocated status for the target member of the target mode. In a case where the CPU 101 determines that both of the two levels of operation input that can be detected by the target member have function invoking disabled, the CPU 101 advances the processing to S1304. In a case where the CPU 101 determines that at both of the two levels of operation input that can be detected by the target member do not have function invoking disabled, that is, at least one type of operation input has function invoking enabled, the CPU 101 advances the processing to S1303.

In S1303, the CPU 101 tentatively selects, as the function to be allocated to the corresponding operation member of the target mode, the function with function invoking not disabled from among the functions allocated to the target member of the same target mode. In other words, the CPU 101 tentatively selects the function allocated to the operation input with function invoking enabled as the function to be allocated to the corresponding operation member irrespective of the carry-over settings.

On the other hand, in a case where the CPU 101 determines that function invoking is disabled for both of the two levels of operation input in S1302, in S1304, the CPU 101 tentatively selects to disable function invoking for the corresponding operation member of the target mode.

In S1305, the CPU 101 executes confirmation processing to finally confirm the function allocated to the corresponding operation member of the target mode. In a case where the function allocated to the operation input with function invoking enabled of the target member can be allocated to the corresponding operation member via the confirmation processing of the present step, the corresponding operation member can be made to have one function able to be invoked in a similar manner to the target member. In a case where the function cannot be allocated to the corresponding operation member, either the function allocated by default to the corresponding operation member or the function currently allocated to the corresponding operation member can be allocated to the corresponding operation member of the target mode. Also, in a case where all function invoking of the target member is disabled, the corresponding operation member can be put in a state in which function invoking is disabled in a similar manner to the target member.

As described above, according to the information processing apparatus according to the present modification example, the function allocated to the corresponding operation member of the carry-over destination can be adaptively changed depending on the mode of allocation of the function to the operation member that can detect two levels of operation input of the carry-over source.

### Modification Example 3

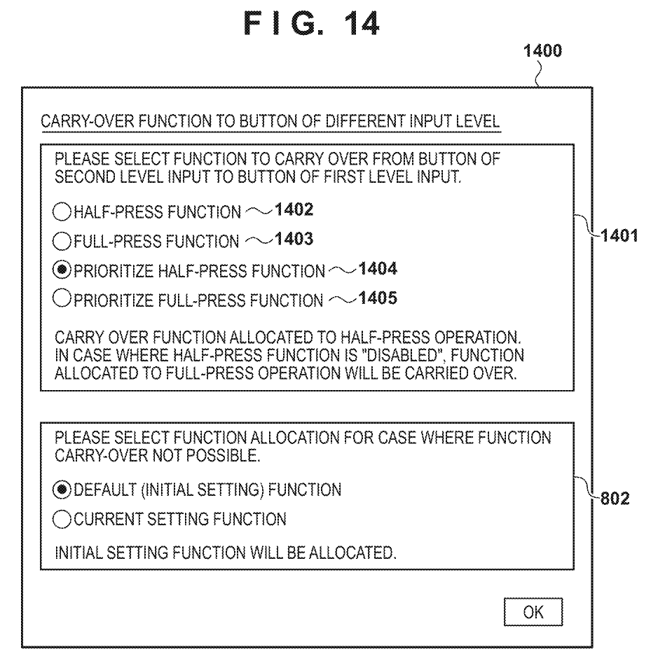

In Modification Example 2 described above, in a case where function invoking is disabled for one of the two levels of operation input that can be detected by the operation member of the carry-over source, the other function is selected as the function to be allocated to the corresponding operation member. However, the present technology is not limited thereto. Carry over as described above with different carry-over settings may be performed only when such a change is desired by the user. In this case, as illustrated in FIG. 14, for example, a carry-over settings screen 1400 may be displayed on the smartphone 100, and the designation of carry-over settings by the user may be received. In the illustrated example, in a setting item 1401, two types of options are further added in the setting item 801 of the carry-over settings screen 800 relating to carrying over a function from an operation member that can detect two levels of operation input to a corresponding operation member that can detect one level of operation input.

A first and second option 1402 and 1403 included in the setting item 1401 correspond to the options illustrated in the setting item 801 of the carry-over settings screen 800. The options 1402 and 1403 are for receiving the carry-over settings for fixedly selecting the function allocated to the first level operation input (half-press operation) of the operation member of the carry-over source as the function to carry over to the corresponding operation member or the function allocated to the second level operation input (full-press operation).

In a case where the carry-over settings are set based on these options, the CPU 101 carries over the settings even if function invoking is disabled for the operation input corresponding to the operation member of the carry-over source. In other words, if function invoking is disabled for an operation input relating to the operation member of the carry-over source selected based on the carry-over settings, the CPU 101 performs control to disable function invoking also for the corresponding operation member of the carry-over destination.

A third and fourth option 1404 and 1405 included in the setting item 1401 are basically for designating an operation input to carry over a function from an operation member of the carry-over source, but the functions carried over if function invoking is disabled for the operation input are different. In other words, the option 1404 is basically for selecting a function relating to a first level operation input of an operation member of the carry-over source as the function to be carried over to the corresponding operation member, but the function relating to the second level operation input is selected if function invoking is disabled for the operation input. In a similar manner, the option 1405 is basically for selecting a function relating to a second level operation input of an operation member of the carry-over source as the function to be carried over to the corresponding operation member, but the function relating to the first level operation input is selected if function invoking is disabled for the operation input.

In a case where the carry-over settings are set based on these options, the CPU 101 carries over the function relating to the operation input even if function invoking is disabled for this operation input of the operation member of the carry-over source and function invoking is enabled for the other operation input. In other words, if function invoking is disabled for one operation input relating to the operation member of the carry-over source selected based on the carry-over settings, the CPU 101 performs control to allocate an enabled function as long as function invoking is enabled for the other operation input.

### Second Embodiment

In the embodiment and modification examples described above, allocation information for allocating to an operation member of the carry-over destination camera 200b is generated and carried over based on the setting information obtained by the smartphone 100 from the carry-over source camera 200a. However, the present technology is not limited thereto, and the function allocation settings for the carry-over source camera may be able to be carried over to another apparatus without intervention of the smartphone 100. In other words, in such an aspect, the smartphone 100 that has the role of a relay is not included. Thus, carry-over processing between a carry-over source electronic device and a carry-over destination electronic device can be closed and carry-over processing can be executed by one of the devices or by the cooperation of both devices.

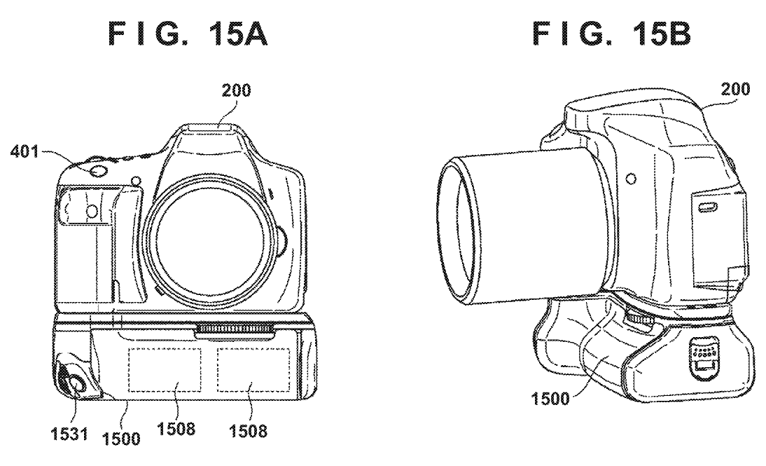

In the mode described below, an accessory apparatus including an operation member that can be used while mounted on and integrally formed with a camera is used as the carry-over destination electronic device for the carry-over of the function allocation settings of the carry-over source camera 200a. Such an accessory apparatus 1500 may be a so-called vertical grip as illustrated in FIGS. 15A and 15B. In this case, in the accessory apparatus 1500, various types of operation members are disposed so that when the camera 200a is held in the vertical orientation (an orientation for capturing images longer in the vertical direction than the horizontal direction), the operation members such as a shutter button and an AF on button are arranged at positions similar to when held in the horizontal orientation.

The accessory apparatus 1500 includes a connection portion configured to be inserted into the space where the battery is inserted in the camera 200a and is configured to be connected in a communication-enabling manner to the camera 200a by the connection portion being inserted while the battery is removed from the space. Alternatively, the accessory apparatus 1500 includes a space where the battery can be inserted and has the role of supplying power to the accessory apparatus 1500 and each block of the camera 200a from the battery inserted into the space when the accessory apparatus 1500 is mounted to the camera 200a and used. Also, the accessory apparatus 1500 can be configured so that an AC adapter can be mounted and can supply power supplied from the AC adapter to the accessory apparatus 1500 and each block of the camera 200a.

### Hardware Configuration of Accessory Apparatus 1500

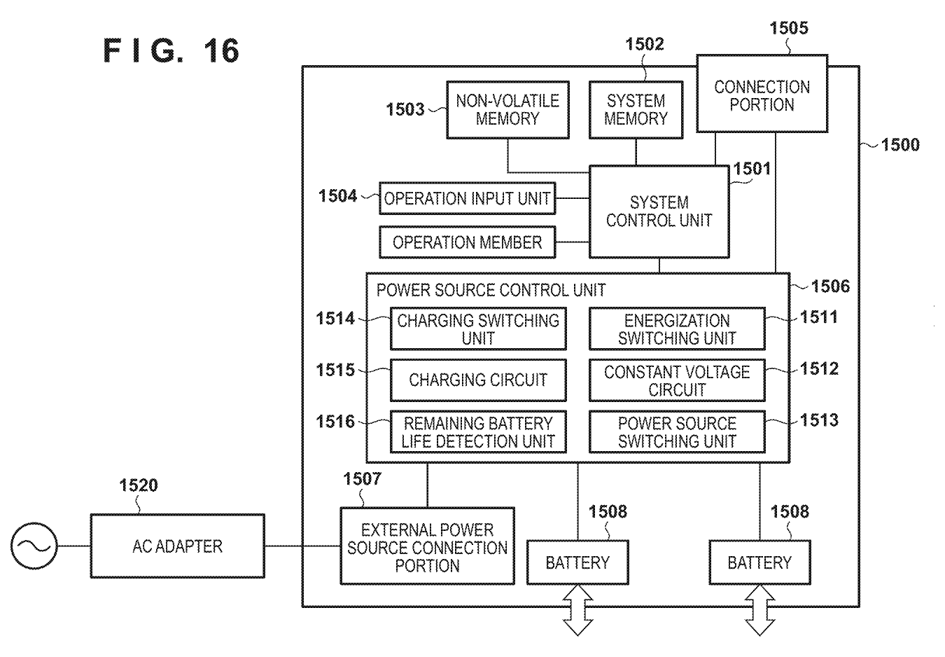

The hardware configuration of the accessory apparatus 1500 will be described below in detail with reference to the block diagram of FIG. 16.

A system control unit 1501 is a control unit including at least one processor or circuit and controls the operation of each block included in the accessory apparatus 1500. The system control unit 1501 loads a program stored in a non-volatile memory 1503 into a system memory 1502 and executes the program to implement each process of the flowchart described below. The non-volatile memory 1503 is a memory which is electrically erasable and recordable, and EEPROM or the like may be used, for example. Constants for operation of the system control unit 1501, programs for energization, charging, and communicating, and the like are stored in the non-volatile memory 1503. Constants and variables for operation of the system control unit 1501 and programs read out from the non-volatile memory 1503 are loaded on the system memory 1502 which uses RAM, for example.

A power source control unit 1506 includes an energization switching unit 1511, a constant voltage circuit 1512, a power source switching unit 1513, a charging switching unit 1514, a charging circuit 1515, and a remaining battery life detection unit 1516.

The power source control unit 1506 controls the constant voltage circuit 1512 based on detection results from the remaining battery life detection unit 1516 and an instruction from the system control unit 1501 and supplies the required power to each component element of the accessory apparatus 1500 in the required time period. Also, the power source control unit 1506 supplies power to the camera 200a connected via a connection portion 1505. Here, the connection portion 1505 is an interface for connecting in a communication-enabling manner the camera 200a and the accessory apparatus 1500 and includes a predetermined electrical contact. The energization switching unit 1511 is constituted of a switch circuit for switching the supply destination. A battery 1508 is a battery that can be charged such as a lithium ion battery, for example. The accessory apparatus 1500 is configured such that two of the batteries 1508 can be loaded into it.

The power source switching unit 1513 switches between supplying power from either an external power source such as an AC adapter 1520 connected to an external power source connection portion 1507 or the two batteries 1508 to each component element of the accessory apparatus 1500 or the camera 200a. Note that the power source switching unit 1513 may be able to switch so that the power supply from the camera 200a is made the power source.

In a case where the power of the connected camera 200a is in an off state, the power source control unit 1506 controls the charging of the batteries 1508. Also in a case where the camera 200a is in a non-connected state and the AC adapter 1520 or the like is connected to the external power source connection portion 1507 and supplying power, the power source control unit 1506 controls the charging of the batteries 1508. The charging switching unit 1514 controls which of the batteries 1508 to charge based on the remaining life detection result of the batteries 1508 by the remaining battery life detection unit 1516. The charging circuit 1515 is a circuit configured to charge a single battery of the batteries 1508 housed in the accessory apparatus 1500.

An operation input unit 1504 includes an input interface, such as various types of operation members included in the accessory apparatus 1500, configured to detect an operation input. When an operation input on each input interface is detected, the operation input unit 1504 outputs a control signal corresponding to the operation input to the system control unit 1501. When the control signal is received, the system control unit 1501 transfers the same control signal to the system control unit 201 of the camera 200a via the connection portion 1505.

### Examples of Various Types of Operation Members

Here, examples of the operation member included in the accessory apparatus 1500 will be described. At least one operation member included in the accessory apparatus 1500 shares a function allocated by default with the camera 200a and is set with the same name. Such an operation member includes a shutter button and an AF on button. In a case where the camera 200a is held in the horizontal orientation, the operation members (the shutter button 401 and the AF on button 414) with the same name in the camera 200a are disposed at a position where the index finger and the thumb of the right hand of the user gripping the grip of the camera 200a rest. Thus, in a case where the camera 200a to which the accessory apparatus 1500 is mounted is held in the vertical orientation, the same operation member included in the accessory apparatus 1500 is disposed at a position where the index finger and the thumb of the right hand of the user gripping the grip of the accessory apparatus 1500 rest. In other words, the operation members are disposed at different positions but are provided so that the positional relationships with the fingers of the user gripping the grip correspond irrespective of whether the camera 200a is in the horizontal orientation or the vertical orientation. In the example of FIG. 15A, only a shutter button 1531 included in the accessory apparatus 1500 is illustrated. The shutter button 1531 is disposed at a position corresponding to the shutter button 401 in the horizontal orientation of the camera 200a, in a case where the camera 200a is rotated 90 degrees to the right about the optical axis in the diagram and gripped in the vertical orientation. The AF on button (not illustrated) included in the accessory apparatus 1500 is disposed at a position on the back surface similarly not illustrated in FIG. 15A corresponding to the AF on button 414 when the camera 200a is at the horizontal orientation.

On the other hand, in the accessory apparatus 1500 according to the present embodiment, the AF on button is an input interface that uses operation members of different systems between the camera 200a and the accessory apparatus 1500. In the present embodiment, in the camera 200a, the AF on button 414 is configured to detect two levels of operation input relating to the press-down amount. On the other hand, in the accessory apparatus 1500, the AF on button is configured to detect one level of operation input, that is, whether it is pressed or not. Hereinafter, to distinguish between the AF on button 414 included in the camera 200a and the AF on button included in the accessory apparatus 1500, the latter will be referred to as an accessory AF on button.

### Overview of Carry-over of Function Allocation Settings

In the present embodiment, an aspect in which the accessory apparatus 1500 is mounted on the camera 200a and used will be described, with the function allocation settings for an operation member included in the camera 200a being carried over to an operation member included in the accessory apparatus 1500. In other words, in the present embodiment, the carry-over source electronic device is the camera 200a, and the carry-over destination electronic device is the accessory apparatus 1500. Note that, as described below, the carry-over processing relating to carry-over of the function allocation settings is executed by the system control unit 201 of the carry-over source camera 200a at the timing when connection of the accessory apparatus 1500 to the camera 200a is detected, for example.

The carry-over of the function allocation settings from the camera 200a to the accessory apparatus 1500 is performed basically as in the first embodiment. In other words, one of the first function and the second function allocated to the AF on button 414 that can detect two levels of operation input, based on the carry-over settings, may be confirmed as the function to be allocated to the accessory AF on button.

Here, the accessory apparatus 1500 according to the present embodiment is an electronic device that is expected to be used together with the camera 200a. In other words, when the user holds the camera 200a in the horizontal orientation or the vertical orientation to match the adopted composition relating to image capture, the operation member disposed on the grip held at this time is used to perform various types of operation input. Specifically, in a case where the user holds the camera 200a in the horizontal orientation, the shutter button 401 and the AF on button 414 of the camera 200a are used, and in a case where the user holds the camera 200a in the vertical orientation, the shutter button 1531 and the accessory AF on button of the accessory apparatus 1500 are used.

At this time, in an aspect in which only one of the first function and the second function allocated to the AF on button 414 is allocated to the accessory AF on button, the operation feeling of the AF on button is different depending on whether the camera 200a is in the horizontal orientation or in the vertical orientation. In other words, in a case where the camera 200a is held in the horizontal orientation, the user can selectively use the two levels of operation input for the AF on button 414 and invoke two types of functions. On the other hand, in a case where the camera 200a is held in the vertical orientation, the user can only invoke a single function (the first function or the second function) via one level of operation input of the accessory AF on button. This discrepancy in operation feeling between the corresponding operation members may cause a situation in which the user makes operation errors and cannot capture an image at the suitable timing.

Thus, in the present embodiment, the operation feeling between the corresponding operation members can be unified during use of both the carry-over source camera 200a and the carry-over destination accessory apparatus 1500. In other words, in a case where one function from among the first function and the second function allocated to the carry-over source operation member is allocated to the corresponding operation member which is the carry-over destination, by making the other function unable to be invoked by the carry-over source operation member, a unified operation feeling can be achieved across the operation members. That is, in an aspect in which function allocation settings are carried over between operation members with a different number of levels for an operation input that can be detected, control is performed so that the carry-over source operation member that can detect a greater number of levels of operation input is aligned with the corresponding operation member which is the carry-over destination so that only a single function can be invoked.

Note that unifying the operation feeling may be performed in a case where the first function or the second function allocated to the carry-over source operation member is to be allocated to the corresponding operation member which is the carry-over destination. In other words, in the case of allocating the function set by default to the corresponding operation member in the carry-over destination accessory apparatus 1500, that is, in the case of allocating a function not based on the function allocation settings for the carry-over source operation member, the operation feeling may not be unified. This is because, if the function allocation settings for the corresponding operation member which is the carry-over destination are not to be carried over from the carry-over source operation member, the roles are different as evidenced by the different functions invoked by these operation members. Thus, there is little need to unify the operation feeling.

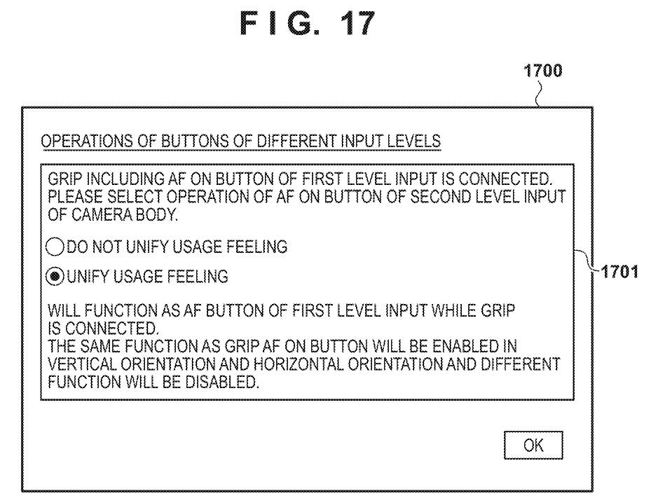

The control relating to unifying the operation feeling may be performed based on a user selection received via a carry-over settings screen such as that illustrated in FIG. 17, for example, that inquires whether or not to unify the operation feeling in the case of carrying over the function allocation settings and using the accessory apparatus 1500. A carry-over settings screen 1700 may be displayed on the rear display unit 220 of the camera 200a, for example, and receive an instruction from the user as to whether or not to unify the operation feeling. In the illustrated example, in a setting item 1701 in the carry-over settings screen 1700, two types of options are included for instructing whether to keep the same operation feeling in the case of carrying over a function from an operation member that can detect two levels of operation input to a corresponding operation member that can detect one level of operation input. The information of the user selection relating to whether or not to unify the operation feeling received via the carry-over settings screen 1700 is included in the carry-over settings information, for example, and stored in the non-volatile memory 256 or the like.

### Determination Processing

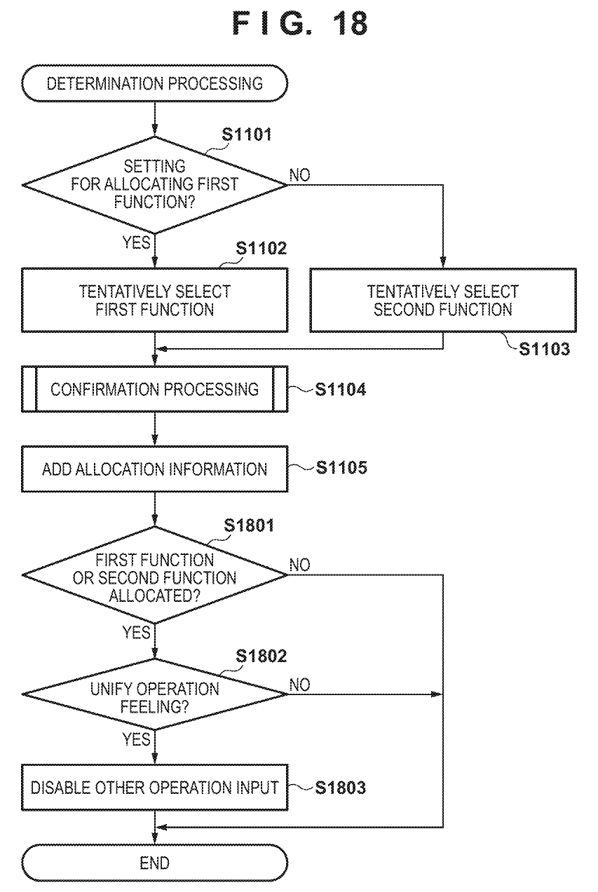

The determination processing executed in the camera 200a according to the present embodiment will be described below in detail with reference to the flowchart of FIG. 18. Note that in the description of the determination processing according to the present embodiment, steps in which processing is executed that is similar to the determination processing of the first embodiment will be given the same reference number and will not be described. Mainly, only processing specific to the present embodiment will be described below. Also, the carry-over processing including the determination processing is executed in the camera 200a which is different from the first embodiment. Thus, the executing entity is changed from the CPU 101 to the system control unit 201. In other words, from among steps included in the determination processing according to the present embodiment, the carry-over processing including the generation processing in which the determination processing is executed, and the confirmation processing executed due to the determination processing, steps not described below have their operating entity appropriately substituted for the system control unit 201. For the storage apparatus for storing the various types of information referenced in these steps, a storage apparatus such as the non-volatile memory 103 or the like included in the smartphone 100 is appropriately substituted for a storage apparatus such as the non-volatile memory 256 or the like included in the camera 200a. Also, for the carry-over destination electronic device in these items of processing, the camera (camera 200b) is substituted for the accessory apparatus 1500 as necessary.

In S1105, when allocation information of the corresponding operation member of the target mode is added to the carry-over information, in S1801, the system control unit 201 determines whether the first function or the second function relating to the target member of the same operation mode has been allocated to the corresponding operation member of the target mode. In a case where the system control unit 201 determines that either the first function or the second function relating to the target member has been allocated to the corresponding operation member, the system control unit 201 advances the processing to S1802, and in a case where the system control unit 201 determines that neither have been allocated, the system control unit 201 ends the present determination processing.

In S1802, the system control unit 201 determines whether or not to unify the operation feeling of the corresponding operation member which is the carry-over destination with the carry-over source target member. The determination of the present step can be performed based on the carry-over settings information, for example. In a case where the system control unit 201 determines to unify the operation feeling of the corresponding operation member which is the carry-over destination with the carry-over source target member, the system control unit 201 advances the processing to S1803, and in a case where the system control unit 201 determines not to unify, the system control unit 201 ends the present determination processing.

In S1803, the system control unit 201 disables function invoking for the operation input corresponding to the function not allocated to the corresponding operation member from among the two levels of operation input that can be detected by the target member of the target mode and ends the present determination processing. In other words, in a case where the second function is allocated to the corresponding operation member, the system control unit 201 disables function invoking for the first level of operation input (half-press operation) of the target member that had been allocated the first function. Also, in a case where the first function is allocated to the corresponding operation member, the system control unit 201 disables function invoking for the second level of operation input (full-press operation) of the target member that had been allocated the second function. For example, for the allocation information of the camera 200a in the mode illustrated in FIG. 7A, in a case where the “Photometry/AF start” function is allocated to the corresponding operation member of the normal mode, function invoking of the second level operation input is disabled and “AF stop” is set to not be invoked. Disabling function invoking may be performed by changing the allocation information of the carry-over source camera (camera 200a), for example.

As described above, in the system according to the present embodiment, in an aspect in which the carry-over source electronic device and the carry-over destination electronic device are both used, it is possible to achieve the carrying over of function allocation settings guaranteeing similar operation feeling. Note that unifying the operation feeling across operation members with different numbers of levels for an operation input that can be detected may be performed only in a time period in which both the carry-over source electronic device and the carry-over destination electronic device are being used. In other words, unifying the operation feeling is so that, in a situation in which the two operation members (carry-over source and carry-over destination operation members) sharing function allocation settings are simultaneously used, invoking the other function via one of the operation members can be avoided. Accordingly, in a situation in which these are not simultaneously used, the disabled function invoking may be activated to guarantee the user convenience of the carry-over source operation member.

### Modification Example 4

In the second embodiment described above, for the carry-over source operation member, whether or not to unify the operation feeling with the corresponding operation member which is the carry-over destination is changed based on a user selection received via the carry-over settings screen 1700 illustrated in FIG. 17. However, the present technology is not limited thereto, and whether or not to unify the operation feeling across these operation members may be determined independent of settings set by the user. For example, in a case where the carry-over destination electronic device is an electronic device that is used together with the carry-over source, the system control unit 201 may determine to unify the operation feeling of the operation member.

### Modification Example 5

In the second embodiment described above, the accessory apparatus 1500, which is a kind of vertical orientation grip, is used as an example of a carry-over destination electronic device that is simultaneously used with the carry-over source electronic device (camera 200a). However, the present technology is not limited thereto. The carry-over destination electronic device is not limited to a device that is used together with the carry-over source electronic device and can include, for example, a remote controller, a remote control application executed on a communication terminal, and the like, which are configured to communicate with the electronic device.

### Third Embodiment

In the function allocation settings for carry-over according to the embodiment and modification examples described above, the carry-over source operation member can detect two levels of operation input, and the corresponding operation member which is the carry-over destination can detect one level of operation input. However, the present technology is not limited thereto, and in another mode, carry-over processing may be executed with the carry-over source operation member being able to detect one level of operation input and the carry-over destination operation member being able to detect two levels of operation input.

### System Configuration

The system according to the present embodiment includes a configuration such as that illustrated in FIG. 1B. As illustrated, in the present embodiment, a smartphone 100 that has obtained setting information indicating the allocation of a function to each type of operation member in the camera 200b allocates a function to each type of operation member in the camera 200a based on the setting information.

### Overview of Carry-over of Function Allocation Settings

Next, an overview of carry-over relating to operation members with different numbers of levels that can be detected according to the present embodiment will be described.

In the system according to the present embodiment, the AF on button 414 included in the camera 200b and the AF on button 414 included in the camera 200a have a different detectable number of levels for an operation input. Specifically, the AF on button 414 of the camera 200b is configured to detect one level of operation input, but the AF on button 414 of the camera 200a is configured to detect two levels of operation input. In this case, a suitable carry-over is not achieved even if the function allocated to the operation member is carried over as is. In other words, since the detectable number of levels for an operation input is different between the carry-over source (camera 200b) and the carry-over destination (camera 200a), a function allocation that can guarantee an operation feeling similar to that of the carry-over source cannot be implemented.

Thus, in the smartphone 100 according to the present embodiment, when executing carry-over processing, a determination is performed for whether or not the number of levels for an operation input that can be detected is the same across operation members corresponding to the carry-over source and the carry-over destination. Then, in a case where the number of levels for an operation input that can be detected is different across corresponding operation members, that is, in a case where the corresponding operation member which is the carry-over destination has a greater number of levels for an operation input that can be detected, carry-over of one function (referred to below as a third function) allocated to the carry-over source operation member is adjusted. In the present embodiment, since the corresponding operation member which is the carry-over destination is configured to detect two levels of operation input, it is determined in the carry-over processing which level of operation input the third function to be carried over is to be invoked in response to. Thus, in the examples of FIGS. 5A and 5B, since the number of levels that can be detected for the AF on button 414 differs between the carry-over source and the carry-over destination, it is determined which operation input detectable with the same button of the camera 200a the function allocated to the same button of the camera 200b is to be allocated to.

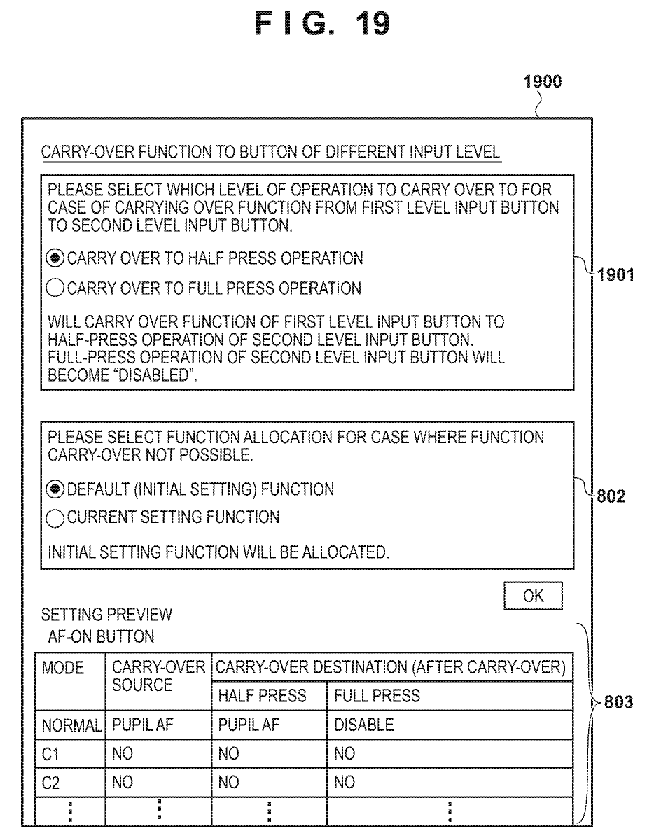

In one aspect, for allocation from the carry-over source operation member that can detect one level of operation input, it may be determined based on predetermined carry-over settings information to which of the two levels of operation input dtectable by the corresponding carry-over destination operation member the allocation is to be made. The carry-over settings may be set on the smartphone 100 via a carry-over settings screen 1900 such as that illustrated in FIG. 19, for example.

In the example of FIG. 19, the carry-over settings screen 1900 is configured to allow the user to designate how to perform carry-over of function allocation settings for an operation member of the carry-over source that can detect one level of an operation input to a corresponding operation member of the carry-over destination that can detect two levels of operation input. Specifically, in the case of carry-over of function allocation settings for an operation member with such a relationship, the carry-over settings screen 1900 includes a setting item 1901 for designating which level operation input that can be detected by the corresponding operation member to allocate the third function for invoking. In the setting item 1901 of the illustrated example, in a case where the carry-over destination operation member is configured to detect only one level for an operation input, the user can designate whether to carry over the function allocated to the first level operation input (half-press operation) or the function allocated to the second level operation input (full-press operation) of the same carry-over source operation member. In other words, in the setting item 1901, an allocation rule can be set as to which operation input detectable by the carry-over destination operation member the third function relating to the carry-over source operation member is to be allocated to. Information of the user selection relating to the operation input of the corresponding operation member for carry-over of the function allocated to the operation member that can detect one level of operation input received via the carry-over settings screen 1900 is, for example, included in the carry-over settings information and stored in the non-volatile memory 103 or the like.

However, in a case where the third function allocated to the carry-over source operation member is allocated to one of the operation inputs that can be detected by the carry-over destination operation member, the function allocation to the other operation input that was not allocated with the third function being left as is may reduce the ease-of-use. For example, in an aspect in which the allocation information is as illustrated in FIGS. 7A and 7B, the third function allocated to the carry-over source AF on button 414 in the normal mode is “Pupil AF”. At this time, in the case of carrying over the function to the first level operation input of the carry-over destination AF on button 414, after carry-over, the carry-over destination AF on button 414 is configured to invoke the function “Pupil AF” with the first level operation input and the function “AF stop” with the second level operation input. However, the carry-over source AF on button 414 is configured to invoke only the function “Pupil AF” and is not configured to invoke the function “AF stop”. In other words, if the carry-over processing ends with the third function carried over to only one of the operation inputs detectable by the corresponding operation member which is the carry-over destination, a deviation will occur between the carry-over source operation member and the corresponding operation member which is the carry-over destination. Thus, in the carry-over processing according to the present embodiment, when the third function is allocated to one of the operation inputs of the corresponding operation member which is the carry-over destination, control is performed to disable function invoking for the other operation input not allocated. In other words, the corresponding operation member which is the carry-over destination is changed to be configured to invoke only one function as with the carry-over source operation member.

### Generation Processing

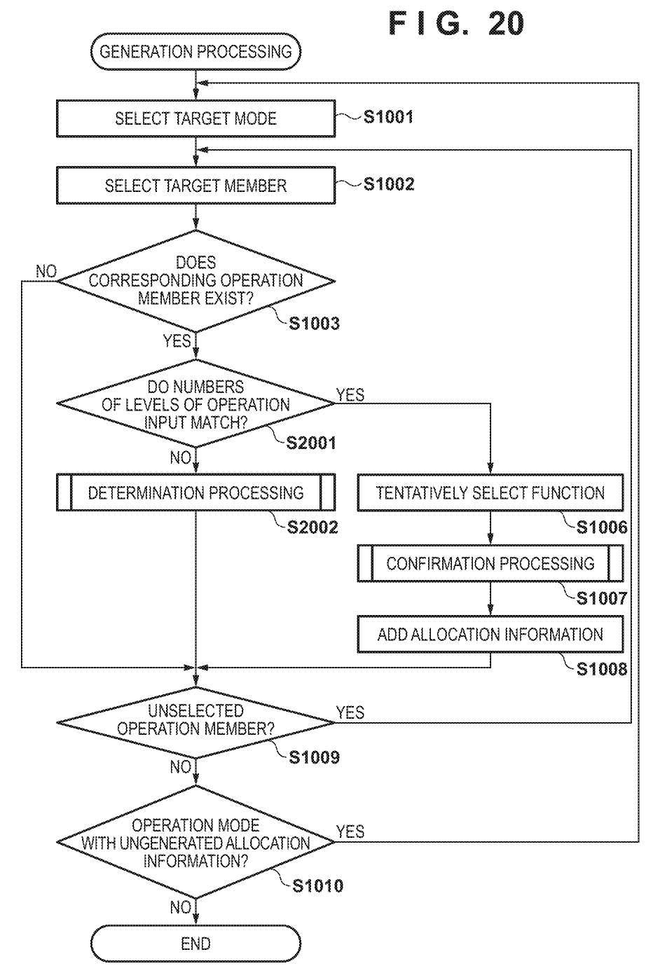

Here, generation processing executed according to the present embodiment will be described in detail with reference to the flowchart of FIG. 20. Note that in the description of the generation processing according to the present embodiment, steps in which processing is executed that is similar to the generation processing of the first embodiment will be given the same reference number and will not be described. Mainly, only processing specific to the present embodiment will be described below.

In S1003, in a case where it is determined that a corresponding operation member exists at the carry-over destination, in S2001, the CPU 101 determines whether or not the number of levels for an operation input that can be detected by the target member matches the number of levels for an operation input that can be detected by the corresponding operation member. In a case where the CPU 101 determines that the number of levels for the operation input that can be detected by the target member matches the number of levels for the operation input that can be detected by the corresponding operation member, the CPU 101 advances the processing to S1006, and in a case where the CPU 101 determines that they do not match, the CPU 101 advances the processing to S2002.

In S2002, the CPU 101 executes determination processing to determine the function to allocate to the corresponding operation member for the target mode. In other words, the CPU 101 executes determination processing according to the present embodiment in order to determine the function allocation to carry over to the corresponding operation member that can detect two levels for the operation input from the target member that can detect one level for the operation input.

### Determination Processing

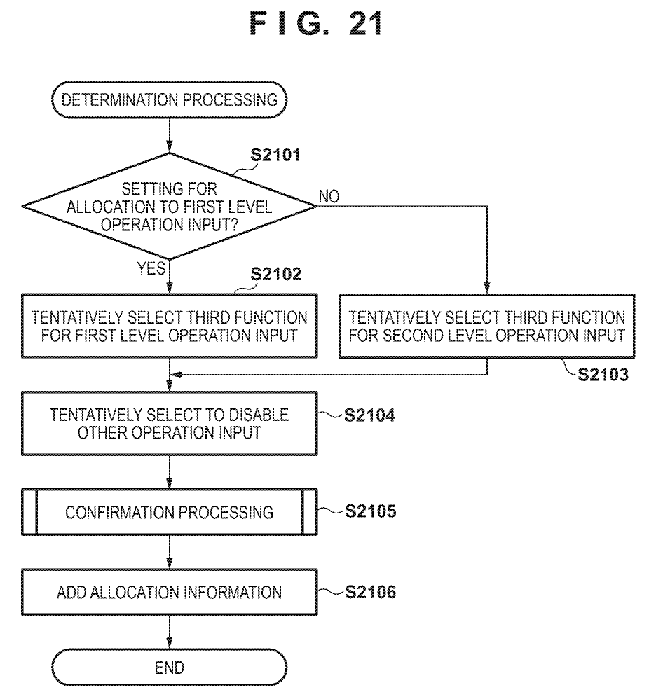

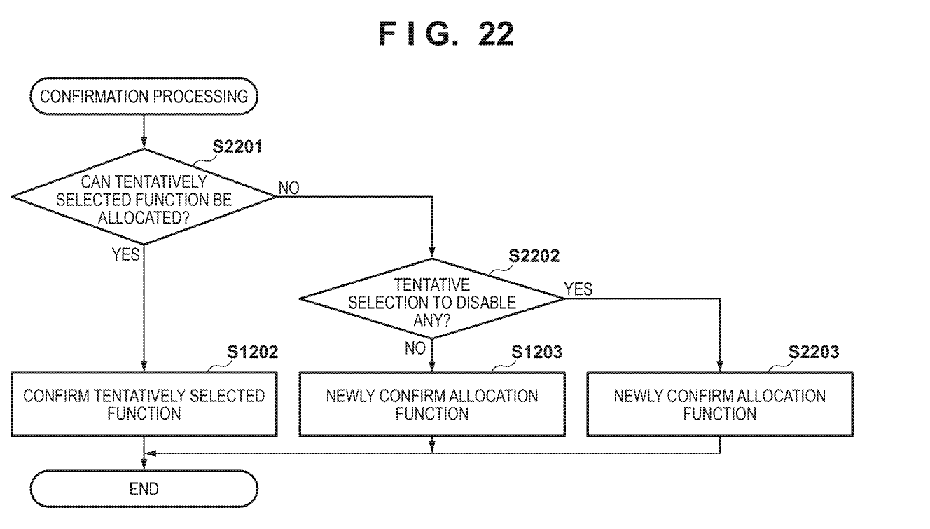

Here, the determination processing executed in the present step will be described in detail with reference to the flowchart of FIG. 21.

In S2101, the CPU 101 determines whether or not allocation of the third function to the first level operation input of the corresponding operation member has been set in the carry-over settings. In a case where the CPU 101 determines that allocation of the third function to the first level of the operation input of the corresponding operation member has been set, the CPU 101 advances the processing to S2102. Also, in a case where the CPU 101 determines that allocation of the third function to the first level of the operation input of the corresponding operation member has not been set, that is, that allocation to the second level operation input of the corresponding operation member has been set, the CPU 101 advances the processing to S2103.

In S2102, the CPU 101 tentatively selects, as the function to be allocated to the first level operation input of the corresponding operation member of the target mode, the third function allocated to the target member of the same target mode. In other words, the CPU 101 tentatively selects the third function allocated to be invoked for the target mode when an operation input to the target member is detected as the candidate for the function to be invoked when a first level operation input to the corresponding operation member is detected.

On the other hand, in a case where the CPU 101 determines that allocation of the third function to the second level operation input of the corresponding operation member has been set in S2101, in S2103, the CPU 101 tentatively selects the third function as the function to be allocated to the second level operation input of the corresponding operation member of the target mode. In other words, the CPU 101 tentatively selects the third function allocated to be invoked for the target mode when an operation input to the target member is detected as the candidate for the function to be invoked when a second level operation input to the corresponding operation member is detected.

In S2104, the CPU 101 tentatively determines to disable function invoking for, from among the two levels of operation input that can be detected by the corresponding operation member of the target mode, the operation input not allocated with the third function in S2102 or S2103. In other words, in a case where the third function is tentatively selected as the function to be allocated to the first level operation input of the corresponding operation member of the target mode in S2102, the CPU 101 tentatively determines to disable function invoking for the second level operation input of the corresponding operation member. Also, in a case where the third function is tentatively selected as the function to be allocated to the second level operation input of the corresponding operation member of the target mode in S2103, the CPU 101 tentatively determines to disable function invoking for the first level operation input of the corresponding operation member.

In S2105, the CPU 101 executes confirmation processing according to the present embodiment to finally confirm the function allocated to the corresponding operation member of the target mode.

### Confirmation Processing

The confirmation processing executed in the present step will now be described with reference to the flowchart of FIG. 22. Note that in the description of the confirmation processing according to the present embodiment, steps in which processing is executed that is similar to the confirmation processing of the first embodiment will be given the same reference number and will not be described. Mainly, only processing specific to the present embodiment will be described below.

In S2201, the CPU 101 determines whether or not the function allocated to the corresponding operation member of the target mode that is tentatively selected can be allocated to the corresponding operation member. Here, in an aspect in which the target member can detect one level of operation input and the corresponding operation member can detect two levels of operation input, disabling of function invoking is tentatively selected for one of the operation inputs that can be detected by the corresponding operation member. In this case, the CPU 101 determines whether or not the corresponding operation member can be allocated based on only the function tentatively selected for the other operation input with function invoking not disabled. In a case where the CPU 101 determines that the tentatively selected function can be allocated to the corresponding operation member, the CPU 101 advances the processing to S1202. In this case, in S1202, the CPU 101 confirms, for the two levels of operation input that can be detected by the corresponding operation member, to allocate one with the third function and to disable function invoking for the other. Also, in a case where the CPU 101 determines that the tentatively selected function cannot be allocated to the corresponding operation member, the CPU 101 advances the processing to S2202.

In S2202, the CPU 101 determines whether or not any of the two levels of operation input that can be detected by the corresponding operation member of the target mode is tentatively selected to have function invoking disabled. In other words, in the present step, the CPU 101 determines whether or not the situation is a situation in which any of the operation inputs that can be detected by the corresponding operation member are to be disabled. In a case where the CPU 101 determines that any of the two levels of operation input that can be detected by the corresponding operation member of the target mode is tentatively selected to have function invoking disabled, the CPU 101 advances the processing to S2203, and in a case where the CPU 101 determines that any of the two levels are not selected, the CPU 101 advances the processing to S1203.

In S2203, the CPU 101 confirms the function to be allocated to each of the two levels of operation input that can be detected for the corresponding operation member of the target mode and ends the present confirmation processing. Specifically, the CPU 101 determines the function to be allocated instead of disabling function invoking for the operation input tentatively selected to have function invoking disabled, from among the two levels of operation input of the corresponding operation member. Also, the CPU 101 in a similar manner determines the function to be allocated for the other operation input, that is, the operation input not selected to have function invoking disabled. The function to be allocated to each level of the operation input at this time is determine not based on the first allocation information relating to the target member of the target mode. In other words, for both of the two levels of operation input that can be detected by the corresponding operation member of the target mode, the CPU 101 confirms either the function allocated by default to the corresponding operation member or the function currently allocated to the corresponding operation member as the function to be allocated.

When the confirmation processing ends in this manner, the CPU 101 advances the processing to S2106.

In S2106, for the corresponding operation member of the target mode, the CPU 101 adds the allocation information including the information of the function confirmed as a result of the confirmation processing to the carry-over information and ends the present determination processing.

As described above, according to the information processing apparatus according to the present embodiment, a configuration can be used that guarantees an operation feeling similar to that of the carry-over source operation member when carry-over of function allocation settings to an operation member with a greater number of levels for an operation input that can be detected.

Note that in the present embodiment described above, function invoking is disabled for, from among the operation inputs that can be detected by the corresponding operation member which is the carry-over destination, the operation input not allocated with a function relating to the carry-over source operation member. However, the present technology is not limited thereto. For example, a configuration may be used that allows the user to select a function to be allocated to the operation input in a case where the carry-over processing ends without a function being allocated to the operation input but an operation input is detected for the corresponding operation member thereafter.

### Modification Example 6

In the embodiments and modification examples described above, allocation of a function to an operation member (allocation of a function different from the function allocated by default) is performed for all operation modes of the carry-over source camera. However, the present technology is not limited thereto, and for example, the state may be a state in which function allocation has not been performed (not set) for one or more of the operation members, for example. In this case, for the operation member for which function allocation has not been performed, in a similar manner to a case where allocation to the corresponding operation member cannot be performed, for example, either the function allocated by default to the corresponding operation member or the function currently allocated to the corresponding operation member may be allocated. In other words, in such a case, the function allocation settings are not carried over.

### Modification Example 7

In the embodiments and modification examples described above, for the carry-over source operation member and the corresponding operation member which is the carry-over destination, the function allocation settings are carried over from an operation member that can detect one level of operation input to an operation member that can detect two levels of operation input. However, the present technology is not limited thereto, and a combination of number of levels for operation input that can be detected by the operation member (first operation member) included in the carry-over source electronic device and the corresponding operation member (second operation member) included in the carry-over destination electronic device can include other modes. According to the present technology, in an aspect in which the first operation member includes a greater number of levels for operation input that can be detected than the second operation member, it is sufficient that one or more of the functions allocated to the different levels of operation input of the first operation member is determined as a function to be allocated to an operation input of the second operation member. Also, according to the present technology, in an aspect in which the second operation member includes a greater number of levels for operation input that can be detected than the first operation member, it is sufficient that a function allocated to the different levels of operation input of the first operation member is determined as a function to be allocated to one or more levels of operation input of the second operation member. In other words, according to the present technology, in a case where the number of levels of operation input that can be detected is different between the first operation member and the second operation member, it is sufficient that carry-over is performed so that the function allocated to the operation input of the first operation member and the function allocated to the operation input of the second operation member are partially shared. Such an aspect of carry-over of the function allocation settings may be determined based on carry-over settings according to user settings received via the carry-over settings screen or may be determined based on another rule.

Note that in the embodiments and modification examples described above, generation processing and determination processing have been separately described for each of an aspect in which the first operation member includes one level of operation input that can be detected and the second operation member includes two levels and an aspect in which the first operation member includes two levels of operation input that can be detected and the second operation member includes two levels. However, the present technology is not limited thereto, and the processing may be adaptively switched according to the relationship of the number of levels of an operation input that can be detected between the first operation member and the second operation member.

### Modification Example 8

As described in the second embodiment, the carry-over processing as described in the embodiments and modification examples described above does not need to be executed in an information processing apparatus external to the carry-over source and carry-over destination electronic device such as the smartphone 100. The carry-over processing may be executed in the carry-over source electronic device and the carry-over destination electronic device, for example. In an aspect in which the carry-over settings referenced in the carry-over processing are set based on user input, the device that receives the user operation relating to the carry-over settings, that is, the device that displays the carry-over settings screen, does not need to be the same device as the electronic device that executes the carry-over processing. Setting the carry-over settings may be performed based on information input to a device different from the electronic device that executes the carry-over processing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-233108, filed December 27, 2024 which is hereby incorporated by reference herein in its entirety.

What is claimed is:

1. An information processing apparatus that allocates, to an operation member included in an electronic device, a function invoked in response to detection of operation input to the operation member, comprising:
at least one processor and/or circuit; and
at least one memory storing a computer program, which causes the at least one processor and/or circuit to function as the following units:
an obtaining unit configured to obtain setting information indicating allocation of a function to an operation member included in a first electronic device; and
an allocating unit configured to allocate a function to an operation member included in a second electronic device based on the setting information,
wherein the operation member is configured to detect one or more levels of operation input and be allocated a function invoked in response to detection of operation input for each of the one or more levels of operation input,
the allocating unit includes an identifying unit configured to identify a second operation member included in the second electronic device corresponding to a first operation member included in the first electronic device, and
in a case where a total number of levels of operation input that can be detected is different between the first operation member and the second operation member, the allocating unit determines a function to be allocated to operation input of the second operation member in such a manner that the function allocated to operation input of the second operation member is in common with a function allocated to operation input of the first operation member.

2. The information processing apparatus according to claim 1, wherein
in a case where the first operation member can detect a greater number of levels of operation input than the second operation member, the allocating unit determines a function among the functions allocated to the levels of operation input of the first operation member as the function to be allocated to operation input of the second operation member.

3. The information processing apparatus according to claim 1, wherein
in a case where the first operation member can detect two levels of operation input and the second operation member can detect one level of operation input, the allocating unit determines one of a first function and a second function allocated to respective levels of operation input of the first operation member as the function to be allocated to operation input of the second operation member.

4. The information processing apparatus according to claim 3, wherein
the allocating unit selects the one of the first function and the second function based on a predetermined selection rule, and determines the selected function as the function to be allocated to operation input of the second operation member.

5. The information processing apparatus according to claim 4, wherein
the allocating unit changes function allocation of the first operation member so as not to invoke, for an unselected function that is not selected as the function to be allocated to operation input of the second operation member, the unselected function of the first operation member even when a level of operation input allocated to the unselected function is detected.

6. The information processing apparatus according to claim 5, wherein
the second electronic device is an electronic device used together with the first electronic device, and
the allocating unit makes the change to function allocation of the first operation member only in a time period in which the second electronic device and the first electronic device are both used.

7. The information processing apparatus according to claim 3, wherein
in a case where either the first function and the second function is disabled, the allocating unit determines another non-disabled function as the function to be allocated to operation input of the second operation member.

8. The information processing apparatus according to claim 3, wherein
in a case where both the first function and the second function are disabled, the allocating unit determines the function to be allocated to operation input of the second operation member independently of the functions allocated to the first operation member.

9. The information processing apparatus according to claim 1, wherein
in a case where the second operation member can detect a greater number of levels of operation input than the first operation member, the allocating unit determines each function allocated to a level of operation input of the first operation member as a function to be allocated to a level of operation input of the second operation member.

10. The information processing apparatus according to claim 9, wherein
in a case where the first operation member can detect one level of operation input and the second operation member can detect two levels of operation input, the allocating unit determines a third function allocated to operation input of the first operation member as the function to be allocated to operation input of the second operation member.

11. The information processing apparatus according to claim 10, wherein
the allocating unit determines which of the levels of operation input of the second operation member the third function is to be allocated to, based on a predetermined allocation rule.

12. The information processing apparatus according to claim 11, wherein
the allocating unit disables the function allocated to the level of operation input to which the third function is not allocated out the two levels of operation input that can be detected by the second operation member.

13. The information processing apparatus according to claim 12, wherein
the disabling of the allocated function is achieved by either controlling the function so as not to be invoked even when the corresponding level of operation input is detected, or by not allocating the function.

14. The information processing apparatus according to claim 1, wherein
in a case where the function determined to be allocated to the second operation member based on one or more functions allocated to the first operation member is a function that cannot be allocated to the second operation member, the allocating unit determines the function to be allocated to operation input of the second operation member independently of the one or more functions allocated to the first operation member.

15. The information processing apparatus according to claim 1, wherein
the information processing apparatus is one of the first electronic device and the second electronic device.

16. A control method for an information processing apparatus that allocates, to an operation member included in an electronic device, a function invoked in response to detection of operation input to the operation member, comprising:
obtaining setting information indicating allocation of a function to an operation member included in a first electronic device; and
allocating a function to an operation member included in a second electronic device based on the setting information,
wherein the operation member is configured to detect one or more levels of operation input and be allocated a function invoked in response to detection of operation input for each of the one or more levels of operation input,
the allocating includes identifying a second operation member included in the second electronic device corresponding to a first operation member included in the first electronic device, and
the allocating includes, in a case where a total number of levels of operation input that can be detected is different between the first operation member and the second operation member, determining a function to be allocated to operation input of the second operation member in such a manner that the function allocated to operation input of the second operation member is in common with a function allocated to operation input of the first operation member.

17. A computer-readable storage medium storing a program for causing a computer to execute the control method according to claim 16.
